(19) United States
(12) Patent Application Publication
(10) Pub. No.: US 2009/0074989 A1
(43) Pub. Date: Mar. 19, 2009

(54) Cellulose Ester Film, Manufacturing Method Thereof, Optical Film, Polarizing Plate and Liquid Crystal Display

(75) Inventors: Kazuaki Nakamura, Kyoto (JP); Kazuto Kiyohara, Tokyo (JP); Satomi Kawabe, Tokyo (JP); Akihiko Takeda, Kanagawa (JP); Yasushi Okubo, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 11/911,602

(22) PCT Filed: Apr. 11, 2006
(86) PCT No.: PCT/JP2006/307609

§ 371 Date: Oct. 15, 2007

(30) Foreign Application Priority Data
Apr. 18, 2005 (JP) 2005-119514

(51) Int. Cl. C09K 19/02; B32B 27/36; C09D 101/08; B29C 39/00

(52) U.S. Cl. 428/1.1; 428/480; 536/58; 106/168.01; 106/170.51; 106/170.42; 106/170.15; 106/170.26; 264/330

(57) ABSTRACT

An objective is to provide a cellulose ester film which can reduce a manufacturing burden and a facility burden caused by drying and recovering of a solvent used in the production process, a manufacturing method of the cellulose ester film and an optical film, and to specifically provide a polarizing plate employing the optical film as an excellent polarizing plate protective film exhibiting reduced fluctuation of retardation property in the width direction and a liquid crystal display employing the polarizing plate. Also disclosed is a cellulose ester film containing at least one compound having a phenol structure and a phosphite ester structure in a molecule.

### TECHNICAL FIELD

The present invention relates to a cellulose ester film formed by a melt cast method, a manufacturing method thereof, an optical film, a polarizing plate employing the optical film as a polarizing plate protective film, and a liquid crystal display employing the polarizing plate.

### BACKGROUND

A liquid crystal display device (LCD) has been widely used as a display device for a word processor, a personal computer, a TV, a monitor and a portable information terminal, since it is capable of being directly connected to an IC circuit with a low voltage and small electric power consumption, and particularly capable of being produced as a thin device. As to a basic structure, the LCD has a polarizing plate provided on the both sides of a liquid crystal cell.

A polarizing plate passes only a polarized wave plane in the definite direction. Therefore, an LCD bears an important role to visualize the variation of orientation of a liquid crystal caused by the variation of electric field. That is, performance of an LCD depends largely on performance of a polarizing plate.

A polarizer of a polarizing plate is composed of a polymer film to which iodine or such is adsorbed, and then is stretched. That is, after a solution called H ink containing a dichromic substance (iodine) has been wet-adsorbed to a polyvinyl alcohol film, the film is mono-axially stretched to make the dichromic substance oriented in one direction. As a protective film for a polarizing plate, cellulose resin or specifically cellulose acetate has been utilized.

A cellulose film has been commonly utilized since it is optically and physically useful as a protective film for a polarizing plate. However, because the manufacturing method of the film has been a cast film formation method with a halogen-containing solvent, the cost to recover the solvent has been a rather heavy load. Therefore, solvents other than a halogen-containing solvent have been tested in various ways, however, no substitute to provide satisfactory solubility was found. In addition to seeking for a solvent substitution, a new dissolution method such as a cooling method has been tested (for example, refer to Patent Document 1), but it is practically difficult to be realized in an industrial application and further investigation has been desired.

On the other hand, disclosed is a technique to improve spectroscopic and mechanical properties by adding a hindered phenol antioxidant, a hindered amine photo-stabilizer or an acid scavenger into cellulose ester at a given addition rate (for example, refer to Patent Document 2). Also disclosed are a technique utilizing a polyhydric alcohol ester plasticizer (for example, refer to Patent Document 3) and a technique utilizing a polyhydric alcohol ester plasticizer having a specific structure (for example, refer to Patent Document 4). Further, as a technique to inhibit deterioration of an organic material, known is a stabilizer composition containing a stabilizer and a phosphite ester (for example, refer to Patent Document 5).

In recent years, an attempt at melt cast film formation of cellulose ester, for application in silver halide photography or polarizer protective film, has been made, but since cellulose ester is a polymer having very high viscosity at molten state and has a high glass transition temperature, leveling of the film is difficult when cellulose ester is molten and extruded from dice to be cast on a cooling drum or on a cooling belt, and because it solidifies in a short time after extruded, it has been found that such a cellulose ester film has problems in loss of flatness, tendency to cause curling, loss of dimensional stability, unevenness in retardation, and specifically unevenness in retardation in the width direction of the film as an optical property in comparison to that of a solution cast film. Further, since cellulose ester was made of natural cellulose as raw material, and it contained polysaccharide such as lignin, for example, as impurities, a technique typically applied for a thermoplastic resin such as polyethylene, for example, was very difficult to be directly utilized to improve thermal stability. Specifically, in the case of display application, no product at a standing level of long use has been obtained because of coloring caused by lack of thermal stability of impurities.

Patent Document 1: Japanese Patent O.P.I. Publication No. 10-95861

Patent Document 2: Japanese Patent O.P.I. Publication No. 2003-192920

Patent Document 3: Japanese Patent O.P.I. Publication No. 2003-12823

Patent Document 4: Japanese Patent O.P.I. Publication No. 2003-96236

Patent Document 5: Japanese Patent O.P.I. Publication No. 11-222493

Patent Document 6: Published Japanese Translation of PCT International Application Publication No. 6-501040

Patent Document 7: Japanese Patent O.P.I. Publication No. 2000-352620

### DISCLOSURE OF THE INVENTION

It is an object of the present invention to provide a cellulose ester film which can reduce a manufacturing burden and a facility burden caused by drying and recovering of a solvent used in the production process, a manufacturing method of the cellulose ester film and an optical film, and to specifically provide a polarizing plate employing the optical film as an excellent polarizing plate protective film exhibiting reduced fluctuation of retardation property in the width direction and a liquid crystal display employing the polarizing plate.

The above object of the present invention is accomplished by the following structures.

(Structure 1) A cellulose ester film comprising a compound having a phenol structure and a phosphite ester structure in the molecule.

(Structure 2) The cellulose ester film of Structure 1, wherein the compound is represented by Formula (I):

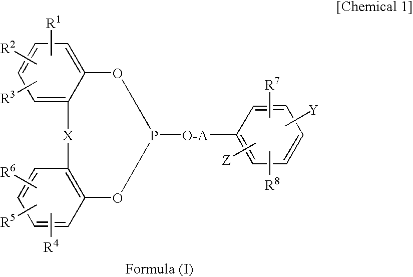

wherein each of R¹, R², R⁴, R⁵, R⁷ and R⁸ independently represents a hydrogen atom, an alkyl group having 1-8 carbon atoms, a cycloalkyl group having 5-8 carbon atoms, an alkylcycloalkyl group having 6-12 carbon atoms, an aralkyl group having 7-12 carbon atoms or a phenyl group; each of R³ and R⁶ independently represents a hydrogen atom or an alkyl group having 1-8 carbon atoms; X represents a single bond, a sulfur atom or a —CHR⁹— group (R⁹ represents a hydrogen atom, an alkyl group having 1-8 carbon atoms or a cycloalkyl group having 5-8 carbon atoms); A represents an alkylene group having 2-8 carbon atoms or a *—COR¹⁰— group (R¹⁰ represents a single bond or an alkylene group having 1-8 carbon atoms, and * represents a bond combining with an oxygen atom); and either Y or Z represents a hydroxyl group, an alkoxy group having 1-8 carbon atoms or an aralkyloxy group having 7-12 carbon atoms, and the other represents a hydrogen atom or an alkyl group having 1-8 carbon atoms.

(Structure 3) The cellulose ester film of Structure 1 or 2, wherein the cellulose ester film comprises one stabilizer selected from the group consisting of a phenol stabilizer, a hindered amine stabilizer, a phosphorus stabilizer and a sulfur stabilizer in an amount of 0.01-5 parts by weight, based on 100 parts by weight of the cellulose ester.

(Structure 4) The cellulose ester film of any one of Structures 1-3, wherein the cellulose ester contained in the cellulose ester film comprises one selected from the group consisting of cellulose acetate, cellulose propionate, cellulose butyrate, cellulose acetate propionate, cellulose acetate butyrate, cellulose acetate phthalate and cellulose phthalate.

(Structure 5) The cellulose ester film of any one of Structures 1-4, containing at least one of an ester plasticizer formed from a polyhydric alcohol and a monocarboxylic acid, and an ester plasticizer formed from a polycarboxylic acid and a monoalcohol.

(Structure 6) The cellulose ester film of Structure 5, wherein the ester plasticizer formed from a polyhydric alcohol and a monocarboxylic acid, and the ester plasticizer formed from a polycarboxylic acid and a monoalcohol are alkyl polyhydric alcohol aryl ester and dialkyl carboxylic acid alkyl ester, respectively.

(Structure 7) An optical film comprising the cellulose ester film of any one of Structures 1-6.

(Structure 8) A polarizing plate comprising the optical film of Structure 7 provided on at least one surface of a polarizer.

(Structure 9) A liquid crystal display device having at least one of the optical film of Structure 7 and the polarizing plate of Structure 8.

(Structure 10) A method of manufacturing the cellulose ester film comprising the step of heat-melting at a melting temperature of 150-300° C. an admixture containing the cellulose ester of having a water content of 3.0% by weight or less; at least one of the ester plasticizer formed from a polyhydric alcohol and a monocarboxylic acid, and the ester plasticizer formed from a polycarboxylic acid and a monoalcohol; and at least one compound having a phenol structure and a phosphite ester structure in a molecule to obtain the cellulose ester film via a melt cast method, wherein the at least one of the ester plasticizer formed from a polyhydric alcohol and a monocarboxylic acid, and the ester plasticizer formed from a polycarboxylic acid and a monoalcohol, and the at least one compound having a phenol structure and a phosphite ester structure in a molecule have a content of 1-30% by weight and a content of 0.01-5% by weight, based on the weight of the cellulose ester.

### DESCRIPTION OF THE PREFERRED EMBODIMENTS

It is a feature in the present invention that a cellulose ester film contains at least one compound having a phenol structure and a phosphite ester in a molecule.

A solution cast method as one of cellulose ester film manufacturing methods comprises the steps of casting on a support a cellulose ester solution in which the cellulose ester is dissolved in a solvent to form a wet cellulose ester web on the support, and evaporating the solvent in the web, whereby the web is dried to obtain a cellulose ester film. This method requires removal of the residual solvent of the wet cellulose ester web, and therefore, it requires energy for drying, an apparatus for collecting the evaporated solvent, and an apparatus for regenerating the collected solvent, resulting in increase of appliance investment and manufacturing cost. Reduction of the appliance investment and manufacturing cost has been sought.

In contrast, a melt cast method does not employ a solvent for dissolving cellulose ester, and therefore, does not have load for appliance investment or drying.

When an un-dried cellulose ester is formed into a film using the melt cast method, small bubbles are generated at the time of molding, resulting in deterioration of optical properties such as haze, transmittance, and retardation. By performing melt casting using a cellulose ester exhibiting water content not greater than 5.0% by weight, haze is reduced as a result of reduced water content whereby optical properties are improved. Also by using an ester plasticizer formed from a polyalcohol and a monocarboxylic acid, and/or an ester plasticizer formed from a polycarboxylic acid and a monoalcohol as the plasticizer, affinity to the cellulose ester is increased and as a result, optical and mechanical properties of the cellulose ester film are enhanced.

When a cellulose ester film is manufactured by a melt cast method after adding a compound having a phenol structure and a phosphite ester structure of the present invention in a molecule, retardation in the width direction, surprisingly, becomes even. It is also known that using a primary antioxidant typified by hindered phenol and a sulfur-containing compound, or phosphite ester and a secondary antioxidant typified by hindered amine in combination is to suppress deterioration of polymeric compounds caused by heat and light, but surprisingly, excellent haze and dimensional stability have been produced by utilizing a compound having the phenol structure and the phosphite ester structure in a molecule.

Further, when a cellulose ester film is manufactured by the foregoing solution cast method, a luminescent foreign material is generated, but on the other hand, when a cellulose ester film is manufactured by a melt cast method, the number of this luminescent foreign material is reduced.

The melt cast method is defined as a method which comprises the steps of heat-melting cellulose ester without using a solvent at temperature exhibiting its fluidity to obtain a fluid cellulose ester and then casting the fluid cellulose ester on a support. Methods for the heat-melting can be classified into a melt extrusion molding method, a press molding method, an inflation method, an ejection molding method, a blow molding method, and an stretch molding method. Of these, the melt extrusion method is excellent in obtaining an optical film with excellent mechanical strength and excellent surface accuracy. As the manufacturing process of the cellulose ester film of the invention, there is, for example, a method which comprises the steps of heat-melting a cellulose ester composition constituting the cellulose ester film at temperature exhibiting its fluidity to melt and then extruding and casting the melted composition on a support such as a drum or an endless belt to form a web.

Among compounds having a phenol structure and a phosphite ester structure utilized for a cellulose ester film of the present invention, an example of a specifically preferable compound is phosphite ester represented by foregoing Formula (I).

In phosphite ester represented by Formula (I) in the present invention, each of R¹, R², R⁴, R⁵, R⁷ and R⁸ independently represents a hydrogen atom, an alkyl group having 1-8 carbon atoms, a cycloalkyl group having 5-8 carbon atoms, an alkylcycloalkyl group having 6-12 carbon atoms, an aralkyl group having 7-12 carbon atoms or a phenyl group having 7-12 carbon atoms. It is preferred that R¹, R² and R⁴ independently represent an alkyl group having 1-8 carbon atoms, a cycloalkyl group having 5-8 carbon atoms or an alkylcycloalkyl group having a total carbon atom number 6 to 12, a hydrogen atom, and R⁵ represents a hydrogen atom, an alkyl group having 1-8 carbon atoms or a cycloalkyl group having 5-8 carbon atoms.

In the above, examples of the alkyl group having 1-8 carbon atoms include methyl, ethyl, n-propyl, i-propyl, n-butyl, i-butyl, sec-butyl, t-butyl, t-pentyl, i-octyl, t-octyl and 2-ethylhexyl. Examples of the cycloalkyl group having 5-8 carbon atoms include cyclopentyl, cyclohexyl, cycloheptyl and cyclooctyl. Examples of the alkylcycloalkyl group having a total carbon atom number 6-12 include 1-methylcyclopentyl, 1-methylcyclohexyl and 1-methyl-4-isopropylcyclohexyl. Examples of the aralkyl group having a total carbon atom number 7-12 include benzyl, α-methylbenzyl and α,α-dimethylbenzyl.

R¹ and R⁴ are preferably a t-alkyl group (e.g., t-butyl, t-pentyl or t-octyl), cyclohexyl, or 1-methylcyclohexyl. R² is preferably alkyl having 1-5 carbon atoms, e.g., methyl, ethyl, n-propyl, i-propyl, n-butyl, i-butyl, sec-butyl, t-butyl or t-pentyl, and more preferably methyl, t-butyl or t-pentyl. R⁵ is preferably a hydrogen atom, or alkyl having 1 to 5 carbon atoms, e.g., methyl, ethyl, n-propyl, i-propyl, n-butyl, i-butyl, sec-butyl, t-butyl or t-pentyl.

Each of R³ and R⁶ independently represents a hydrogen atom or an alkyl group having 1-8 carbon atoms. Examples of the alkyl group having 1-8 carbon atoms are the same as those denoted in R¹, R² and R⁴ above. R³ is preferably a hydrogen atom or an alkyl group having 1-5 carbon atoms, and more preferably a hydrogen atom or methyl.

X represents a single bond, a sulfur atom, methylene or methylene having an alkyl group having 1 to 8 carbon atoms or a cycloalkyl group having 5 to 8 carbon atoms. Herein, examples of the alkyl group having 1 to 8 carbon atoms or the cycloalkyl group having 5 to 8 carbon atoms are the same as those denoted in R¹, R² and R⁴ above. X is preferably a single bond, methylene or methylene having methyl, ethyl, n-propyl, i-propyl, n-butyl, i-butyl or t-butyl.

A represents an alkylene group having 2-8 carbon atoms or a *—COR¹⁰— group (R¹⁰ represents a single bond or an alkylene group having 1-8 carbon atoms, and * represents a bond combining with an oxygen atom). Herein, examples of the alkylene group having 2-8 carbon atoms include ethylene, propylene, butylene, pentamethylene, hexamethylene, octamethylene, 2,2-dimethyl-1,3-propylene. Propylene is preferable. Symbol * in *—COR¹⁰— group means that carbonyl is bonded with oxygen of phosphite. Examples of the alkylene group having 1-8 carbon atoms in R¹⁰ include ethylene, propylene, butylene, pentamethylene, hexamethylene, octamethylene, 2,2-dimethyl-1,3-propylene. R¹⁰ is preferably a single bond or ethylene.

Either Y or Z represents a hydroxyl group, an alkoxy group having 1-8 carbon atoms or an aralkyloxy group having 7-12 carbon atoms, and the other represents a hydrogen atom or an alkyl group having 1-8 carbon atoms. Herein, examples of the alkyl group having 1-8 carbon atoms include those denoted in the foregoing alkyl group having 1-8 carbon atoms, and examples of the alkoxy group having 1 to 8 carbon atoms are an alkoxy group whose alkyl is the same as those denoted in the foregoing alkyl group having 1-8 carbon atoms. Examples of the aralkyloxy group having a total carbon atom number of 7-12 are an aralkyloxy group whose aralkyl is the same as those denoted in the aralkyl group having 7-12 previously.

The phosphite ester represented by Formula (I) can be prepared, for example, by reacting a bisphenol compound represented by Formula (II), phosphorus trihalogenide and a hydroxy compound represented by Formula (III).

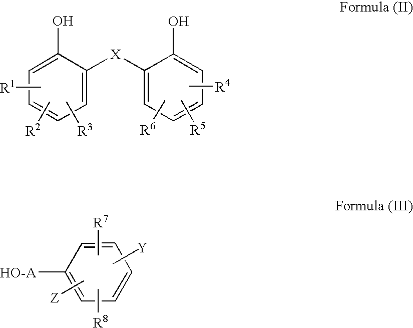

In the above Formulae, R¹, R², R³, X, R⁴, R⁵, R⁶, R⁷, R⁸, A, Y, and Z are common to those described before.

Examples of a bisphenol compound represented by Formula (II) include: 2,2′-methylene-bis(4-methyl-6-t-butylphenol), 2,2′-methylene-bis(4-ethyl-6-t-butylphenol), 2,2′-methylene-bis(4-n-propyl-6-t-butylphenol), 2,2′-methylene-bis(4-i-propyl-6-t-butylphenol), 2,2′-methylene-bis(4-n-butyl-6-t-butylphenol), 2,2′-methylene-bis(4-i-butyl-6-t-butylphenol), 2,2′-methylene-bis(4,6-di-t-butylphenol), 2,2′-methylene-bis(4-t-pentyl-6-t-butylphenol), 2,2′-methylene-bis(4-nonyl-6-t-butylphenol), 2,2′-methylene-bis(4-t-octyl-6-t-butylphenol), 2,2′-methylene-bis(4-methyl-6-t-pentylphenol), 2,2′-methylene-bis(4-methyl-6-cyclohexylphenol), 2,2′-methylene-bis[4-methyl-6-(α-methylcyclohexyl)phenol], 2,2′-methylene-bis(4-methyl-6-nonylphenol), 2,2′-methylene-bis(4-methyl-6-t-octylphenol), 2,2′-methylene-bis(4,6-di-t-pentylphenol), 2,2′-methylene-bis[4-nonyl-6-(α-methylbenzyl)phenol], 2,2′-methylene-bis[4-nonyl-6-(α,α-dimethylbenzyl)phenol] and 2,2′-ethylidene-bis(4-methyl-6-butylphenol).

Examples of a hydroxy compound represented by Formula (III), when A is an alkylene having 2-8 carbon atoms, include: 2-(3-t-butyl-hydroxyphenyl)ethanol, 2-(3-t-pentyl-4-hydroxyphenyl)ethanol, 2-(3-t-octyl-4-hydroxyphenyl)ethanol, 2-(3-cyclohexyl-4-hydroxyphenyl)ethanol, 2-[3-(1-methylcyclohexyl)-4-Hydroxyphenyl]ethanol, 2-(3-t-butyl-4-hydroxy-5-methylphenyl)ethanol, 2-(3-t-pentyl-4-hydroxy-5-methylphenyl)ethanol, 2-(3-t-octyl-4-hydroxy-5-methylphenyl)ethanol, 2-(3-cyclohexyl-4-hydroxy-5-methylphenyl)ethanol, 2-[3-(1-methylcyclohexyl)-4-hydroxy-5-methylphenyl]ethanol, 2-(3-t-butyl-4-hydroxy-5-ethylphenyl)ethanol, 2-(3-t-pentyl-4-hydroxy-5-ethyl phenyl)ethanol, 2-(3-t-octyl-4-hydroxy-5-ethylphenyl)ethanol, 2-(3-cyclohexyl-4-hydroxy-5-ethylphenyl)ethanol and 2-[3-(1-methylcyclohexyl)-4-hydroxy-5-ethylphenyl]ethanol.

Typical examples of a hydroxy compound represented by Formula (III), when A is a *—COR¹⁰— group, include: 3-t-butyl-2-hydroxybenzoic acid, 3-t-butyl-4-hydroxybenzoic acid, 5-t-butyl-2-hydroxybenzoic acid, 3-t-pentyl-4-hydroxybenzoic acid, 3-t-octyl-4-hydroxybenzoic acid, 3-cyclohexyl-4-hydroxybenzoic acid, 3-(1-methylcyclohexyl)-4-hydroxybenzoic acid, 3-t-butyl-2-hydroxy-5-methylbenzoic acid, 3-t-butyl-4-hydroxy-5-methylbenzoic acid, 5-t-butyl-2-hydroxy-3-methylbenzoic acid, 3-t-pentyl-4-hydroxy-5-methylbenzoic acid, 3-t-octyl-4-hydroxy-5-methylbenzoic acid, 3 cyclohexyl-4-hydroxy-5-methylbenzoic acid, 3-(1-methylcyclohexyl)-4-hydroxy-5-methylbenzoic acid, 3-t-butyl-4-hydroxy-5-ethylbenzoic acid, 3-t-pentyl-4-hydroxy-5-ethylbenzoic acid, 3-t-octyl-4-hydroxy-5-ethylbenzoic acid and 3-cyclohexyl-4-hydroxy-5-ethylbenzoic acid.

Specific examples of a compound represented by Formula (I) are shown below.
Compound 1: 6-[3-(3-tert-butyl-4-hydroxy-5-methylphenyl)propoxy]-2,4,8,10-tetrakis-tert-butyldibenzo[d,f][1.3.2]dioxaphodpepine, and
Compound 2: 6-[3-(3,5-di-tert-butyl-4 hydroxyphenyl)propoxy]-2,4,8,10-tetrakis-tert-butyldibenzo[d,f][1.3.2]dioxaphodpepine.

The weight content of a compound represented by Formula (I) based on cellulose ester for one kind of the compounds is normally 0.001-10.0 parts by weight, preferably 0.01-5.0 parts by weight, and more preferably 0.1-3.0 parts by weight, in 100 parts by weight of cellulose ester.

### (Stabilizer)

In the case of a cellulose ester film of the present invention, added may be at least one stabilizer selected from the group of a phenol stabilizer, a hindered amine stabilizer, a phosphorus stabilizer and a sulfur stabilizer. These stabilizers are selected appropriately and combined with phosphite ester to add into cellulose ester, and a cellulose ester film exhibiting excellent optical properties, specifically an excellent polarizing plate protective film exhibiting reduced fluctuation of retardation property in the width direction can be obtained.

Commonly known phenol stabilizers are preferably usable. For example, acrylate compounds described in Japanese Patent O.P.I. Publication Nos. 63-179953 and 1-168643 such as 2-t-butyl-6-(3-t-butyl-2-hydroxy-5-methylbenzyl)-4-methylphenyl acrylate and 2,4-di-t-amyl-6-(1-(3,5-di-t-amyl-2-hydroxyphenyl)ethyl)phenyl acrylate; alkyl-substituted phenol compounds such as octadecyl-3-(3,5-di-t-butyl-4-hydroxyphenyl)propionate, 2,2′-methylene-bis(4-methyl-6-t-butylphenol), 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis(methylene-3-(3′,5′-di-t-butyl-4′-hydroxyphenylpropionate)methane, namely pentaerythrimethyl-tetrakis(3-(3,5-di-t-butyl-4-hydroxyphenylpropionate)) and triethylene glycol bis-(3-(3-t-butyl-4-hydroxy-5-methylphenyl)propionate); and triazine residue-containing phenol compounds such as 6-(4-hydroxy-3,5-di-t-butylanilino)-2,4-bisoctyl-1,3,5-triazine, 4-bisoctylthio-1,3,5-triazine and 2-octylthio-4,6-bis-(3,5-di-t-butyl-4-oxyanilino)-1,3,5-triazine are cited.

Examples of the hindered amine stabilizer include bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(N-octoxy-2,2,6,6-tetramethyl-4-piperidyl)sebacate, bis(N-benzyloxy-2,2,6,6-tetramethyl-4-piperidyl)sebacate, bis(N-cyclohexyloxy-2,2,6,6-tetramethyl-4-piperidyl)sebacate, bis(1,2,2,6,6-pentamethyl-4-piperidyl)-2-(3,5-di-t-butyl-4-hydroxybenzyl)-2-butylmalonate, bis(1-acroyl-2,2,6,6-tetramethyl-4-piperidyl) 2,2-bis(3,5-di-t-butyl-4-hydroxybenzyl)-2-butylmalonate, bis(1,2,2,6,6-pentamethyl-4-piperidyl)decanedioate, 2,2,6,6-tetramethyl-4-piperidyl methacrylate, 4-[3-(3,5-di-t-butyl-4-hydroxyphenyl)propionyloxy]-1-[2-(3-(3,5-di-t-butyl-4-hydroxyphenyl)propionyloxy)ethyl]-2,2,6,6-tetramethylpiperidine, 2-methyl-2-(2,2,6,6-tetramethyl-4-piperidyl)amino-N-(2,2,6,6-tetramethyl-4-piperidyl)propioneamide, tetrakis(2,2,6,6-tetramethyl-4-piperidyl) 1,2,3,4-butanetetracarboxylate and tetrakis(1,2,2,6,6-pentamethyl-4-piperidyl) 1,2,3,4-butanetetracarboxylate.

The phosphorus stabilizer is not specifically limited, as long as it is one used in general resin industries. Preferable examples thereof include a monophosphite compound such as triphenyl phosphite, diphenyl isodecylphosphite, phenyl diisodecyl phosphite, tris(nonylphenyl)phosphite, tris(dinonylphenyl)phosphite, tris(2,4-di-t-butylphenyl)phosphite, or 10-(3,5-di-t-butyl-4-hydroxybenzyl)-9,10-dihydro-9-oxa-10-phosphaphenanthrene-10-oxide; and a diphosphite compound such as 4,4′-butylidene-bis(3-methyl-6-t-butylphenyl-di-tridecyl phosphite) and 4,4′-isopropylidene-bis(phenyl-dialkyl(C12-C15) phosphite). Of these, monophosphite compounds are preferred, and tris(nonylphenyl)phosphite, tris(dinonylphenyl)phosphite and tris(2,4-di-t-butylphenyl)phosphite are specifically preferable.

Preferable examples of the sulfur stabilizer include dilauryl 3,3-thiodipropionate, dimyristyl 3,3′-thiodipropionate, distearyl 3,3-thiodipropionate, lauryl stearyl 3,3-thiodipropionate, pentaerythritol-tetrakis(β-lauryl-thiopropionate), and 3,9-bis(2-dodecylthioethyl)-2,4,8,10-tetra-oxaspiro[5,5]undecane.

At least one of these stabilizers in the foregoing phosphite ester is usable in combination, and is ordinarily 0.001-10.0 parts by weight, preferably 0.01-5.0 parts by weight, and more preferably 0.1-3.0 parts by weight, based on 100 parts by weight of cellulose ester.

### (Cellulose Ester)

The cellulose ester in the present invention is a single or mixed acid cellulose ester including in the cellulose ester structure at least one of an aliphatic acyl group or a substituted or unsubstituted aromatic acyl group.

Examples of the benzene ring substituent group when the aromatic ring in the aromatic acyl group is a benzene ring include, a halogen atom, a cyano group, an alkyl group, a cycloalkyl group, an alkoxy group, and aryl group, an aryloxy group, an acyl group, a carbonamide group, a sulfonamide group, a ureido group, an aralkyl group, a nitro group, an alkoxy carbonyl group, an aryloxy carbonyl group, an aralkyoxy carbonyl group, a carbamoyl group, a sulfamoyl group, an acyloxy group, an alkenyl group, an alkinyl group, an alkyl sulfonyl group, an aryl sulfonyl group, an alkyloxy sulfonyl group, an aryloxy sulfonyl group, an alkyl sulfonyloxy group, and an aryloxy sulfonyl group, —S—R, —NH—CO—OR, —PH—R, —P(—R)₂, —PH—O—R, —P(—R) (—O—R), —P(—O—R)₂, —PH(═O)—R—P(═O) (—R)₂, —PH(═O)—O—R, —P(═O) (—R) (—O—R), —P(═O) (—O—R), —O—PH(═O)—R, —O—P(═O) (—R)₂—O—PH(═O)—O—R, —O—P(═O) (—R)(—O—R), —O—P(═O) (—O—R)₂, —NH—PH(═O)—R, —NH—P(═O) (—R) (—O—R), —NH—P(═O) (—O—R)₂, —SiH₂—R, —SiH(—R)₂, —Si (—R)₃, —O—SiH₂—R, —O—SiH(—R)₂ and —O—Si(—R)₃. R above is a fatty acid group, an aromatic group, or a heterocyclic group. The number of substituent groups is preferably between 1 and 5, more preferably between 1 and 4 and still more preferably between 1 and 3, and most preferably either 1 or 2. Examples of the substituent group preferably include a halogen atom, cyano, an alkyl group, an alkoxy group, an aryl group, an aryloxy group, an acyl group, a carbonamide group, a sulfonamide group, and a ureido group, and more preferably, a halogen atom, cyano, an alkyl group, an alkoxy group, an aryloxy group, an acyl group, and a carbonamide group, and still more preferably, a halogen atom, cyano, an alkyl group, an alkoxy group, and an aryloxy group, and most preferably, a halogen atom, an alkyl group, and an alkoxy group.

Examples of the halogen atom include a fluorine atom, a chlorine atom, a bromine atom, and an iodine atom. The alkyl group may have ring structure or may be branched. The number of carbon atoms in the alkyl group is preferably 1-20, more preferably 1-12, still more preferably 1-6, and most preferably 1-4. Examples of the alkyl group include methyl, ethyl, propyl, isopropyl, butyl, t-butyl, hexyl, cyclohexyl, octyl and 2-ethyl hexyl. The alkoxy group may have ring structure or may be branched. The number of carbon atoms in the alkoxy group is preferably 1-20, more preferably 1-12, still more preferably 1-6, and most preferably 1-4. The alkoxy group may be further substituted by another alkoxy group. Examples of the alkoxy group include a methoxy, ethoxy, 2-methoxyethoxy, 2-methoxy-2-ethoxyethoxy, butyloxy, hexyloxy and octyloxy.

The number of carbon atoms in the aryl group is preferably 6-20, and more preferably 6-12. Examples of the aryl group include phenyl and naphtyl. The number of carbon atoms in the aryloxy group is preferably 6-20, and more preferably 6-12. Examples of the aryloxy group include phenoxy and naphtoxy. The number of carbon atoms in the acyl group is preferably 1-20, and more preferably 1-12. Examples of the acyl group include hormyl, acetyl, and benzoyl. The number of carbon atoms in the carbonamide group is preferably 1-20, and more preferably 1-12. Examples of the carbonamide include acetoamide and benzamide. The number of carbon atoms in the sulfonamide group is preferably 1-20, and more preferably 1-12. Examples of the sulfonamide include methane sulfonamide, benzene sulfonamide, and p-toluene sulfonamide. The number of carbon atoms in the ureido group is preferably 1-20, and more preferably 1-12. Examples of the ureido group include (unsubstituted) ureido.

The number of carbon atoms in the aralkyl group is preferably 7-20, and more preferably 7-12. Examples of the aralkyl group include benzyl, phenethyl, and naphtyl methyl. The number of carbon atoms in the alkoxycarbonyl group is preferably 1-20, and more preferably 2-12. Examples of the alkoxycarbonyl group include methoxy carbonyl. The number of carbon atoms in the aryloxy carbonyl group is preferably 7-20, and more preferably 7-12. Examples of the aryloxy carbonyl group include phenoxy carbonyl. The number of carbon atoms in the aralkyloxycarbonyl is preferably 8-20, and more preferably 8-12. Examples of the aralkyoxycarbonyl include benzyloxycarbonyl. The number of carbon atoms in the carbamoyl group is preferably 1-20, and more preferably 1-12. Examples of the carbamoyl group include (unsubstituted) carbamoyl and N-methyl carbamoyl. The number of carbon atoms in the sulfamoyl group is preferably no greater than 20, and more preferably no greater than 12. Examples of the sulfamoyl group include (unsubstituted) sulfamoyl and N-methyl sulfamoyl. The number of carbon atoms in the acyloxy group is preferably 1-20, and more preferably 2-12. Examples of the acyloxy group include acetoxy and benzoyloxy.

The number of carbon atoms in the alkenyl group is preferably 2-20, and more preferably 2-12. Examples of the alkenyl group include vinyl, aryl and isopropenyl. The number of carbon atoms in the alkinyl group is preferably 2-20, and more preferably 2-12. Examples of the alkinyl group include dienyl. The number of carbon atoms in the alkyl sulfonyl group is preferably 1-20, and more preferably 1-12. The number of carbon atoms in the aryl sulfonyl group is preferably 6-20, and more preferably 6-12. The number of carbon atoms in the alkyloxy sulfonyl group is preferably 1-20, and more preferably 1-12. The number of carbon atoms in the aryloxy sulfonyl group is preferably 6-20, and more preferably 6-12. The number of carbon atoms in the alkyl sulfonyloxy group is preferably 1-20, and more preferably 1-12. The number of carbon atoms in the aryloxy sulfonyl is preferably 6-20, and more preferably 6-12.

In the cellulose ester of the present invention, in the case where the hydrogen atom of the hydroxyl group portion of the cellulose is a fatty acid ester with a fatty acid acyl group, the number of carbon atoms in the fatty acid acyl group is 2-20, and specific examples thereof include acetyl, propionyl, butyryl, isobutyryl, valeryl, pivaroyl, hexanoyl, octanoyl, lauroyl, stearoyl and the like.

The aliphatic acyl group in the present invention also refers to one which is further substituted, and examples of the substituent include those which when the aromatic ring in the aromatic acyl group described above is a benzene ring, are denoted in the substituents of the benzene ring.

When the ester group of cellulose ester has an aromatic ring, the number of the substituent groups X on the aromatic ring should be 0 or 1-5, preferably 1-3, and 1 or 2 is particularly preferable. In addition, when the number of substituent groups substituted on the aromatic ring is 2 or more, the substituent groups may be the same or different from each other, and they may also bond with each other to form a condensed polycyclic ring (such as naphthalene, indene, indane, phenanthrene, quinoline, isoquinoline, chromene, chromane, phthalazine, acridine, indole, indoline and the like).

In the present invention, the cellulose ester has in the ester group a structure selected from at least one of a substituted or unsubstituted aliphatic acyl group or a substituted or unsubstituted aromatic acyl group, and this may be a single acid cellulose ester or a mixed acid cellulose ester, and two or more types of cellulose esters may be used in combination.

The cellulose ester of the present invention is preferably at least one selected from the group consisting of cellulose acetate, cellulose propionate, cellulose butyrate, cellulose acetate propionate, cellulose acetate butyrate, cellulose acetate phthalate and cellulose phthalate.

The lower aliphatic acid esters such as cellulose acetate propionate and cellulose acetate butyrate, which are preferred as the mixed aliphatic acid cellulose ester, have an acyl group having 2-4 carbon atoms as the substituent. In the present invention, cellulose acetate propionate and cellulose acetate butyrate, which satisfy both Equation (I) and Equation (II) below, are preferred, provided that X represents a degree of substitution of the acetyl group; and Y represents a degree of substitution of the propionyl group or the butyryl group.

2.6≦X+Y≦3.0 Equation (1)

0≦X≦2.5 Equation (2)

Cellulose acetate propionate is preferably used herein, and of the cellulose acetate propionates, those that satisfy 1.9≦X≦2.5 and 0.1≦Y≦0.9 are particularly preferable. The portion of the acyl group that is not substituted is usually a hydroxyl group. These may be synthesized by a known method.

In the cellulose ester used in the present invention, the ratio of the weight average molecular weight Mw/number average molecular weight Mn is preferably 1.5-5.5, while 2.0-5.0 is particularly preferable, 2.5-5.0 is more preferable and 3.0-5.0 is even more preferable.

The cellulose which is the raw material for the cellulose ester of the present invention may be wood pulp or cotton linter, and the wood pulp may be that of a needle-leaf tree or a broad-leaf tree, but that of the broad-leaf tree is more preferable. Cotton linter is preferably used in view of peeling properties at the time of film formation. Cellulose esters made from these substances may be suitably blended or used alone.

For example, the proportion used of cellulose ester from cotton linter: cellulose ester from wood pulp (needle-leaf tree): cellulose ester from wood pulp (broad-leaf tree) may be 100:0:0, 90:10:0, 85:15:0, 50:50:0, 20:80:0, 10:90:0, 0:100:0, 0:0:100, 80:10:10, 85:0:15, and 40:30:30.

### (Inclusion of Additives)

Cellulose ester of the present invention having a water content of 3.0% by weight or less includes at least one kind of additives before heat-melting.

In the present invention, the inclusion of additives does not only refer to the additives enclosed in the inside of cellulose ester, but also refers to the additives being present both in the inside of the cellulose ester and on the outer surface of the cellulose ester.

The inclusion methods of the additives include one in which the cellulose ester is dissolved in a solvent, and then the additives are dissolved or dispersed in the resulting solution, and then the solvent is removed. Known methods are used to remove the solvent, and examples thereof include the liquid drying method, the air drying method, the solvent co-precipitation method, the freeze-drying method, and the solution cast method. The resulting mixture of the cellulose ester and the additives after the removal of the solvent can be prepared so as be in the form of fine particles, granules, pellets, a film or the like. The above inclusion of the additives is performed by dissolving a solid cellulose ester as described above, but this dissolution may be performed at the same time when precipitation of cellulose ester is carried out in synthesizing the cellulose ester.

An example of the liquid drying method is one in which an aqueous solution of an activating agent such as sodium lauryl sulfate is added to a solution in which the cellulose ester and the additives are dissolved, and an emulsion and dispersion is performed. Next, the solvent is removed by normal pressure or reduced pressure distillation, and a dispersant of the cellulose ester having the additives included therein is thereby obtained. In addition, centrifugal separation or decantation is preferably performed in order to remove the active agent. Various methods may be used as the emulsification method, and emulsification device using supersonic waves, high-speed rotational shearing and high pressure may be used.

In the emulsification and dispersion method using ultrasonic waves, a so-called batch method and continuous method may be used. The batch method is suitable for preparation of comparatively small amounts of sample, while the continuous method is suitable for large amounts of sample. In the continuous method, a device such as the UH-600SR (manufactured by SMT Co., Ltd.) may be used. In the case of the continuous method, the amount of time for the irradiation of the supersonic waves can be determined by the capacity of the dispersion chamber/flow rate×circulation frequency. In the case where there is more than one supersonic irradiation device, the total of each irradiation time is determined. The irradiation time for the supersonic waves is no more than 10,000 seconds. Also, if the irradiation time needs to be greater than 10,000 seconds, the processing load becomes large, and the actual emulsion dispersion time must be made shorted be re-selecting the emulsifying agent or the like. As a result, a time exceeding 10,000 seconds is not necessary. It is more preferable that the time is between 10 and 2,000 seconds.

A disperser mixer, a homogenizer, an ultra mixer or the like may be used as the emulsion and dispersion device which uses high-speed rotational shearing, and the viscosity of the liquid at the time of emulsion and dispersion can determine which type of device is used.

For emulsion and dispersion using high pressure, LAB 2000 (manufactured by SMT Co., Ltd.) may be used, but the emulsion and dispersion capability depends on the pressure that is applied to the sample. Pressure in the range of 10⁴-5×10⁵ kPa is preferable.

Examples of the active agent that may be used include a cation surfactant, an anion surfactant, an amphoteric surfactant and a high molecular weight polymer dispersing agent. The active agent used is determined by the solvent and the particle diameter of the target emulsion.

The air drying method is one in which a spray dryer such as GS310 (manufactured by Yamato Scientific Co., Ltd.) is used, and a solution in which the cellulose ester and the additives are dissolved is sprayed.

The solvent co-precipitation method is one in which a solution in which the cellulose ester and the additives are dissolved is added to a poor solvent of the cellulose ester and the additives, whereby precipitation takes place. The poor solvent is freely miscible with the solvent which dissolves the cellulose ester. The poor solvent may also be a mixed solvent. The poor solvent may also be added to a solution of the cellulose and the additives.

A mixture of the cellulose ester and the additives precipitated is filtered, and dried.

In the mixture of the cellulose ester and the additives, the particle diameter of the additives is no greater than 1 μm and preferably no greater than 500 nm, and still more preferably no greater than 200 nm. The smaller the particle size of the additives, the more even the distribution of the mechanical strength and the optical properties of the melt casting, and thus a small particle size is favorable.

It is preferable that the mixture of the cellulose ester and the additives as well as additives added during heat melting are dried prior to or during heat melting. Drying herein refers to removing moisture adsorbed by any of melt materials, as well as water or solvent used during preparing the mixture of the cellulose ester and additives or solvents introduced during synthesizing additives.

The removal method may be any known drying method, and examples include the heating method, the pressure reduction method, the heating and pressure reduction method and the like, and may be performed in the air or in an inert gas environment with nitrogen selected as the inert gas. In view of film quality, it is preferable that these known drying methods are performed in a temperature range where the materials do not decompose.

For example, the amount of moisture or solvent remaining after removal in the drying step is no greater than 10% by weight, preferably no greater than 5% by weight, more preferably no greater than 1% by weight, and still more preferably no greater than 0.1% weight, based on the total weight of materials constituting the film. The drying temperature at this time is preferably between 100° C. and the Tg of the material to be dried. In view of preventing the materials from adhering to each other the drying temperature is preferably between 100° C. and the (Tg-5)° C. and more preferably between 110° C. and the (Tg-20)° C. The drying time is preferably 0.5-24 hours, and more preferably 1-18 hours and still more preferably 1.5-12 hours. If the drying time is less than these ranges, the level of drying will be low or the drying will take too much time. Also, if the material to be dried has a Tg, if it is heated to a drying temperature that is higher than Tg, the material melts and handling is difficult.

The drying stage may be separated into 2 or more stages. For example the melt film may be prepared via storage of the material using a preliminary drying step and a pre-drying step which is performed directly before to one week before the melt layer is prepared.

### (Additives)

Examples of the additives for the cellulose ester of the present invention include at least one of an ester plasticizer formed from a polyhydric alcohol and a monocarboxylic acid, and an ester plasticizer formed from a polycarboxylic acid and a monoalcohol. Other additives that may be included are peroxide decomposers, radical scavengers, metal deactivators, UV absorbents, matting agents, dyes, pigments, and plasticizers other than those described above.

Additives are used to trap material generated when the materials constituting a film are subjected to anti-oxidation and decomposition; to control or prevent the decomposition reaction caused by radicals due to heat or light as well as decomposition reactions of an unknown source; and to control generation of volatile components via change in quality typified by coloration and reduction in molecular weight.

On the other hand, when the materials constituting the film are heat-melted, the decomposition reaction is outstanding and deterioration in strength of the materials sometimes occurs due to coloration or reduction in molecular weight due to the decomposition. Undesired volatile components are also generated via the decomposition reaction of the materials constituting the film.

When the materials constituting the film are heat-melted, the presence of the above-described additives is favorable because this controls deterioration of strength caused by decomposition of the material, and also in view of being able to maintain strength of a material itself. The foregoing additives are desired to be present to produce optical films of the present invention.

In addition, the presence of the foregoing additives during heat melting is favorable in that the creation of coloration in the visible region is controlled and also undesired properties for the optical film such as transmission or haze value caused by incorporating volatile components in a film can be controlled.

Displayed images of a liquid crystal display device of the present invention are affected when haze exceeds 1% in the case of using an optical film in the structures of the present invention, whereby the haze value is preferably less than 1% and more preferably less than 0.5%.

During film preparation, the step to provide retardation depends on controlling degradation in strength of the materials constituting the film or maintaining strength of the material itself. This is attributed to the fact that the materials constituting the film become brittle and heavily deteriorated, breakage tends to occur in a stretching step, and as a result, it becomes difficult to control the retardation value.

A degradation reaction caused by oxygen in the air may occur during storage of the foregoing materials constituting the film or the film formation step. In this case, the stabilizing effects of the foregoing additives and the effect of reducing oxygen concentration in the air may also be used together to realize the present invention. Examples of known techniques include use of nitrogen or argon as inert gas; degasification via reduced pressure to vacuum; and operation in an airtight environment. At least one of these three methods can be used in the presence of the foregoing additives. Deterioration of the material can be controlled by decreasing probability of oxygen in the air in contact with the material constituting the film, whereby this is to be favorable to achieve the object of the present invention.

It is also favorable that the foregoing additives are contained in the materials constituting the film in view of improving an aging storage property for a polarizing plate and a polarizer constituting the polarizing plate of the present invention, in order to utilize an optical film of the present invention as a polarizing plate protective film.

As to a liquid crystal display device equipped with a polarizing plate of the present invention, since the foregoing additives are present in the optical film of the present invention, the aging storage property of the optical film can be improved in view of controlling of the above-described change or deterioration in quality, and the additives produce an excellent effect at the same time, resulting in improving of display quality of the liquid crystal display device, since the optical compensation design of the optical film is possible to function for a long duration.

(Ester Plasticizer Formed from a Polyhydric Alcohol and a Monocarboxylic Acid, and Ester Plasticizer Formed from a Polycarboxylic Acid and a Monoalcohol)

It is favorable to add compounds generally known as plasticizers in view of modification of a film via improvement of a mechanical property, addition of flexibility and water absorption resistance, and reduction of moisture permeability. Further, in the melt cast method of the present invention, the plasticizer is added to lower the melting temperature of the materials constituting the film so as to be lower than the respective glass transition temperature of the employed cellulose ester. At the same heating temperature, the viscosity of the materials constituting the film containing the plasticizer can also be reduced to be less than that of the cellulose ester. In the present invention, the melting temperature for the materials constituting the film refers to a temperature at which the materials become liquid when the materials are sufficiently heated.

In the case of the cellulose ester used singly with a temperature of less than its glass transition temperature, the fluid state for film formation is not produced. However, in the case of a temperature higher than the glass transition temperature, modulus of elasticity or viscosity is reduced via absorption of heat to produce fluid state. In order to melt the materials constituting the film, it is preferable that the added plasticizer has a melting point or a glass transition temperature lower than the glass transition temperature of the cellulose ester, whereby the above-cited objective is satisfied. Further, it is preferable that the ester plasticizer formed from polyhydric alcohol and a monocarboxylic acid and the ester plasticizer formed from a polycarboxylic acid and a monoalcohol have a high affinity for the cellulose ester.

The present invention utilizes at least one of an ester plasticizer formed from a polyhydric alcohol and a monocarboxylic acid and an ester plasticizer formed from a polycarboxylic acid and a monoalcohol.

Specific examples of an ethylene glycol ester plasticizer of a polyhydric ester plasticizer include; ethylene glycol alkyl ester plasticizers such as ethylene glycol acetate, ethylene glycol butyrate and the like; ethylene glycol dicycloalkyl ester plasticizers such as ethylene glycol dicyclopropyl carboxylate, and ethylene glycol dicyclohexyl carboxylate; and ethylene glycol aryl ester plasticizers such as ethylene glycol dibenzoate, and ethylene glycol di-4-methyl benzoate. These alkylate groups, cycloalkylate groups and arylate groups may be the same or different and may further be substituted. The substituent groups may be a mix of alkylate groups, cycloalkylate groups and arylate groups, and the substituent groups may be bonded to each other by covalent linkage. Further, the ethylene glycol portions may be substituted and the ethylene glycol ester part of the structure may be part of the polymer or may be systematically included as a pendant. It may also be introduced into a part of the molecular structure of the additive such as an antioxidant, a acid scavenger, and a UV absorbent.

Examples of a glycerin ester plasticizer, which is a polyhydric alcohol ester plasticizer, include glycerin alky esters such as triaceetin, tributylin, glycerin diacetate carboxylate, and glycerin oleate propionate; glycerin cycloalkyl esters such as glycerin tricyclopropyl carboxylate, and glycerin tricyclohexyl carboxylate; glycerin aryl esters such as glycerin tribenzoate, and glycerin 4-methylbenzoate; diglycerin alkyl esters such as diglycerin tetraacetylate, diglycerin tetrapropionate, digylcerin acetate tricarboxylate, and diglycerin tetralaurate; diglycerin cycloalkyl esters such as diglycerin tetracylobutyl carboxylate, and diglycerin tetracylopentyl carboxylate; and diglycerin aryl esters such as diglycerin tetrabenzoate, and diglycerin 3-methyl benzoate. These alkylate groups, cycloalkyl carboxylate groups and arylate groups may be same or different and may further be substituted. The substituent groups may be a mix of alkylate groups, cycloalkyl carboxylate groups and arylate groups, and the substituent groups may be bonded to each other by common bonds. Further, the glycerin and diglycerin portions may be substituted and the glycerin ester or diglycerin ester part of the structure may be a part of the polymer or may be systematically included as a pendant. It may also be introduced into a part of the molecular structure of the additive such as the antioxidant, the acid scavenger, and the UV absorbent.

Other examples of other polyhydric alcohol ester plasticizers are given in Japanese Patent O.P.I. Publication No. 2003-12823 from paragraphs 30-33.

These alkylate groups, cycloalkyl carboxylate groups and arylate groups may be identical or different and may be further substituted. The alkylate groups, cycloalkyl carboxylate groups and arylate groups may be mixed, and the substituent groups may be bonded to each other by common bonds. Furthermore, the polyhydric alcohol portion may be substituted and polyhydric alcohol part of the structure may be a part of the polymer or may be systematically included as a pendant. It may also be introduced into a part of the molecular structure of the additive such as the antioxidant, the acid scavenger the UV absorbent and the like.

Of ester plasticizers formed from the above-described polyhydric alcohol and a monocarboxylic acid, alkyl polyhydric alcohol aryl esters are preferable; specific examples include ethylene glycol benzoate, glycerin tribenzoate, diglycerin tetrabenzoate and compound 16 which is given as an example in paragraph 32 of Japanese Patent O.P.I. Publication No. 2003-12823.

Specific examples of the carboxylic acid ester plasticizer which is a polycarboxylic acid ester plasticizer include alkyl dicarboxylic acid alkyl ester plasticizers such as didodecyl moranate (C1), dioctyl adipate (C4), dibutyl cevacate (C8) and the like; alkyl dicarboxylic acid cycloalkyl ester plasticizers such as dicyclopentyl succinate, dicyclohexyl adipate and the like; alkyl dicarboxylic acid aryl ester plasticizers such as diphenyl succinate, di-4-methyl phenyl glutarate and the like, cycloalkyl dicarboxylic acid alkyl ester plasticizers such as dihexyl-1,4-cyclohexane dicarboxylate, didecyl bicycle [2.2.1]heptane-2,3-dicarboxylate and the like; cycloalkyl dicarboxylic acid dicycloalkyl ester plasticizers such as dicyclohexyl-1,2-cyclobutane dicarboxylate, dicyclopropyl-1,2-cyclohexyl dicarboxylate and the like; cycloalkyl dicarboxylic acid aryl ester plasticizers such as diphenyl 1,1-cyclopropyl dicarboxylate, di 2-naphtyl-1,4-cyclohexane dicarboxylate and the like; aryl dicarboxylic acid alkyl ester plasticizers such as diethyl phthalate, dimethyl phthalate, dioctyl phthalate, dibutyl phthalate, di-2-ethyl hexyl phthalate and the like; aryl dicarboxylic acid cycloalkyl ester plasticizers such as dicyclopropyl phthalate, dicyclohexyl phthalate and the like; and aryl carboxylic acid aryl ester plasticizers such as diphenyl phthalate, di-4-methyl phenyl phthalate and the like. These alkoxy groups and cycloalkoxy groups may be the same or different, and may also be substituted and the substitution groups may be further substituted. The alkyl groups and the cycloalkyl groups may be mixed, and the substituent groups may be bonded to each other by common bonds. Furthermore, the aromatic ring of the phthalic acid may be substituted and may be polymer such as a dimer, trimer, tetramer and the like. The phthalic acid ester part of the structure may be a part of the polymer or may be systematically included as a pendant. It may also be introduced into a part of the molecular structure of the additive such as the antioxidant, and the acid scavenger the UV absorbent.

The amount of an ester plasticizer formed from a polyhydric alcohol and a monocarboxylic acid or an ester plasticizer formed from a polycarboxylic acid and a monoalcohol incorporated in cellulose ester is preferably 0.1-50 parts by weight, more preferably 1-30 parts by weight, and still more preferably 3-15 parts by weight, based on 100 parts by weight of cellulose ester.

Specific examples of other polycarboxylic acid ester plasticizers include alkyl polycarboxylic acid alkyl ester plasticizers such as tridodecyl tricarbalate, tributyl-meso-butane 1,2,3,4,-tetracarboxylate and the like, alkyl polycarboxylic acid cycloalkyl ester plasticizers such as tricyclohexyl tricarbalate, tricyclopropyl-2-hydroxy 1,2,3-propane tricarboxylate, alkyl polycarboxylic acid aryl ester plasticizers such as triphenyl 2-hydroxyl-1,2,3 propane tricarboxylate, tetra 3-methyl phenyl tetrahydrofuran 2, 3, 4, 5 tetracarboxylate and the like, cycloalkyl polycarboxylic acid alkyl ester plasticizers such as tetrahexyl-1,2,3,4-cyclobutane tetracarboxylate, tetrabutyl 1,2,3,4-dicyclopentane tetracarboxylate and the like, cycloalkyl polycarboxylic acid cycloalkyl ester plasticizers such as tetracyclopropyl-1,2,3,4-cyclobutane tetracarboxylate, tricyclohexyl 1,3,5-cyclohexyl tricarboxylate and the like, cycloalkyl polycarboxylic acid aryl ester plasticizers such as triphenyl-1,3,5-cyclohexyl tricarboxylate, hexa 4-methyl phenyl-1,2,3,4,5,6-cyclohexyl hexacarboxylate and the like, aryl polyhydric carboxylic acid alkyl ester plasticizers such as tridodecyl benzene-1,2,4-tricarboxylate, tetraoctyl benzene-1,2,4,5 tetracarboxylate and the like, aryl polyhydric carboxylic acid cycloalkyl ester plasticizers such as tricyclopentyl benzene-1,3,5-tricarboxylate, tetracyclohexyl benzene-1,2,3,5 tetracarboxylate and the like, and aryl polyhydric carboxylic acid aryl ester plasticizers such as triphenyl benzene-1,3,5-tetracarboxylate, hexa 4-methylphenyl benzene-1,2,3,4,5,6-hexacarboxylate and the like. These alkoxy groups and cycloalkoxy groups may be the same or different, and may also be substituted and the substitution groups may be further substituted. The alkyl groups and the cycloalkyl groups may be mixed, and the substituent groups may be bonded to each other by common bonds. Furthermore, the aromatic ring of the phthalic acid may be substituted and may be a polymer such as a dimer, trimer, tetramer and the like. The phthalic acid ester part of the structure may be a part of the polymer or may be systematically included as a pendant. It may also be introduced into a part of the molecular structure of the additive such as the antioxidant, the acid scavenger the UV absorbent and the like.

Of ester plasticizers formed from the above-described polycarboxylic acid and a monoalcohol, dialkyl carboxylic acid alkyl esters are preferable, and specifically the foregoing dioctyl adipate and tridecyl carboxylate are provided.

### (Other Plasticizers)

Other plasticizers used in the present invention include phosphoric acid ester plasticizers, polymer plasticizers and the like.

Specific examples of the phosphoric acid ester plasticizer include phosphoric acid alkyl esters such as triacetyl phosphate, tributyl phosphate and the like, phosphoric acid cycloalkyl esters such as tricyclopentyl phosphate, cyclohexyl phosphate and the like, phosphoric acid aryl esters such as triphenyl phosphate, tricresyl phosphate, cresylphenyl phosphate, octyldiphenyl phosphate, diphenylbiphenyl phosphate, trioctyl phosphate, tributyl phosphate, trinaphtyl phosphate, triglyceryl phosphate, tris ortho-biphenyl phosphate. The substituent groups for these maybe the same or different, and may be further substituted. The substituent groups may be a mix of alkyl groups, cycloalkyl groups and aryl groups, and the substituent groups may be bonded to each other by common bonds.

Examples of the phosphoric acid ester also include alkylene bis(dialkyl phosphates) such as ethylene his (dimethyl phosphate), butylene his (diethyl phosphate) and the like, alkylene bis(diaryl phosphates such as ethylene bis(diphenyl phosphate), propylene bis(dinaphthyl phosphate) and the like, arylene bis(dialkyl phosphates) such as phenylene his (dibutyl phosphate), biphenylene his (dioctyl phosphate) and the like, arylene bis(diaryl phosphates) such as phenylene his (diphenyl phosphate), naphthylene his (ditriyl phosphate) and the like. These substituent groups may the same or different, and may be further substituted. The substituent groups may be a mix of an alkyl group, cycloalkyl groups and aryl groups, and the substituent groups may be bonded to each other by common bonds.

Furthermore, a part of the structure of the phosphoric acid ester may be a part of the polymer or may be systematically included as a pendant. It may also be introduced into a part of the molecular structure of the additive such as the antioxidant, the acid scavenger, the UV absorbent and the like. Of compounds listed above, aryl ester phosphates and arylene his (diaryl phosphates) are preferable, and more specifically, triphenyl phosphate and phenylene his (diphenyl phosphate) are preferable.

Specific examples of the polymer plasticizer include acrylic polymers such as an aliphatic hydrocarbon polymer, an alicyclic hydrocarbon polymer, polyacrylate ether, methyl polymethacrylate and the like, vinyl polymers such as polyvinyl isobutyl ether, poly N-vinyl pyrrolidone and the like, styrene polymers such as polystyrene, poly 4-hydroxy styrene and the like, polyesters such as polybutylene succinate, polyethylene terephthalate, polyethylene naphthalate and the like, polyethers such as polyethylene oxide, polypropylene oxide and the like, polyamides, polyurethanes, polyurea and the like. The number average molecular weight is preferably about 1,000-500,000 and 5,000-200,000 is particularly preferable. If the number average molecular weight is less than 1,000 there are problems with respect to volatility, while if it exceeds 500,000 the plasticizing properties decrease and the mechanical properties of the cellulose ester derivative composition are adversely affected. The polymer plasticizer may be a homopolymer formed by repeating the same kind of polymer units, or may be a copolymer having a structure in which there is a plurality of repeated units. In addition, 2 or more of the polymers may be used in combination.

The amount of other plasticizer incorporated into cellulose ester is normally 0.1-50 parts by weight, preferably 1-30 parts by weight, and more preferably 3-15 parts by weight in 100 parts by weight of cellulose ester.

### (Antioxidant)

Since decomposition of cellulose ester is accelerated by heat as well as oxygen under a high temperature environment such as in a melt cast process, it is preferable to incorporate an antioxidant as a stabilizer into an optical film of the present invention.

In the present invention, it is also preferable to use an antioxidant in a suspension-washing process of cellulose ester using a poor solvent. Any antioxidant are employable without limitation, as far as the antioxidant contained in a poor solvent inactivates radicals generated in cellulose ester, or the antioxidant restrains deterioration of cellulose ester due to oxygen added to the generated radicals.

An antioxidant utilized in suspension-washing of cellulose ester may remain in cellulose ester after washing. The remaining amount is preferably 0.01-2,000 ppm, more preferably 0.05-1,000 ppm and furthermore preferably 0.1-100 ppm.

As a useful antioxidant in the present invention, a compound which restrains deterioration of the material for forming a cellulose ester film caused by oxygen can be utilized with no limitation, however, examples of a useful compound include: a phenol compound, a hindered amine compound, a phosphorus compound, a sulfur compound, a heat resistant processing stabilizer and an oxygen scavenger. Specifically preferable among them are a phenol compound, a hindered amine compound and a phosphorus compound. By blending such a compound, it is possible to prevent coloring and strength decrease of a cellulose ester film while keeping the transparency or heat resistance of the film. These antioxidants each can be utilized alone or in combination of at least two kinds.

A phenol compound is a compound well known in the art and is described, for example, in columns 12-14 of U.S. Pat. No. 4,839,405 including 2,6-dialkylphenol derivative compounds. Among these compounds, examples of a preferable compound include those represented by Formula (A).

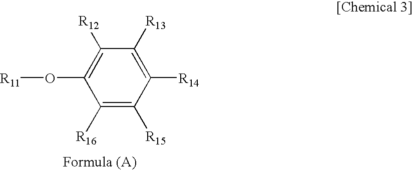

In Formula (A), R₁₁, R₁₂, R₁₃, R₁₄ and R₁₅ each represent a substituent. Examples of the substituent include: a hydrogen atom, a halogen atom (for example, a fluorine atom and a chlorine atom), an alkyl group (for example, a methyl group, an ethyl group, an isopropyl group, a hydroxyethyl group, a methoxy methyl group, a trifluoro methyl group and a t-butyl group), a cycloalkyl group (for example, a cyclopentyl group and a cyclohexyl group), an aralkyl group (for example, a benzyl group and a 2-phenethyl group), an aryl group (for example, a phenyl group, a naphthyl group, p-tolyl group and a p-chlorophenyl group), an alkoxy group (for example, a methoxy group, an ethoxy group, an isopropoxy group and a butoxy group), an aryloxy groups (for example, a phenoxy group), a cyano group, an acylamino group (for example, an acetylamino group and a propionylamino group), an alkylthio group (for example, a methylthio group, an ethylthio group and a butylthio group), an arylthio group (for example, a phenylthio group), a sulfonylamino group (for example, a methanesulfonylamino group and a benzene sulfonyl amino group), an ureido group (for example, a 3-methylureido group, a 3,3-dimethylureido group and a 1,3-dimethylureido group), a sulfamoylamino group (for example, a dimethylsulfamoyl amino group), a carbamoyl group (for example, a methylcarbamoyl group, an ethylcarbamoyl group and a dimethylcarbamoyl group), a sulfamoyl group (for example, an ethylsulfamoyl group and a dimethylsulfamoyl group), an alkoxycarbonyl group (for example, a methoxycarbonyl group and an ethoxycarbonyl group), an aryloxycarbonyl group, (for example, a phenoxycarbonyl group), a sulfonyl group (for example, a methanesulfonyl group, a butane sulfonyl group and a phenylsulfonyl group), an acyl group (for example, an acetyl group, a propanoyl group and a butyroyl group), an amino group (for example, a methylamino group, an ethylamino group and a dimethylamino group), a cyano group, a hydroxy group, a nitro group, a nitroso group, an amineoxide group (for example, a pyridine oxide group), an imide group (for example, a phthalimide group), disulfide group (for example, a benzene disulfide group and a benzothiazolyl-2-disulfide group), a carboxyl group, a sulfo group and a heterocycle group (for example, a pyrrole group, a pyrrolidyl group, a pyrazolyl group, an imidazolyl group, a pyridyl group, a benzimidazolyl group, a benzthiazolyl group and a benzoxazolyl group). These substituents may be further substituted. Further, R11 is preferably a hydrogen atom, and R12 and R16 each are preferably a t-butyl group which is a phenolic compound. Examples of the phenol compound include: n-octadecyl-3-(3,5-di-t-butyl-4-hydroxyphenyl)propionate, n-octadecyl-3-(3,5-di-t-butyl-4-hydroxyphenyl)acetate, n-octadecyl-3,5-di-t-butyl-4-hydroxybenzoate, n-hexyl-3,5-di-t-butyl-4-hydroxyphenylbenzoate, n-dodecyl-3,5-di-t-butyl-4-hydroxyphenylbenzoate, neo-dodecyl-3-(3,5-di-t-butyl-4-hydroxyphenyl)propionate, dodecyl-β-(3,5-di-t-butyl-4-hydroxyphenyl)propionate, ethyl-α-(4-hydroxy-3,5-di-t-butylphenyl)isobutyrate, octadecyl-α-(4-hydroxy-3,5-di-t-butylphenyl)isobutyrate, octadecyl-α-(4-hydroxy-3,5-di-t-butyl-4-hydroxyphenyl)propionate, 2-(n-octylthio)ethyl-3,5-di-t-butyl-4-hydroxy-benzoate, 2-(n-octylthio)ethyl-3,5-di-t-butyl-4-hydroxyphenylacetate, 2-(n-octadecylthio)ethyl-3,5-di-t-butyl-4-hydroxyphenylacetate, 2-(n-octadecylthio)ethyl-3,5-di-t-butyl-4-hydroxybenzoate, 2-(2-hydroxyethylthio)-ethyl-3,5-di-t-butyl-4-hydroxybenzoate, diethylglycol-bis-(3,5-di-t-butyl-4-hydroxyphenyl)propionate, 2-(n-octadecylthio)ethyl-3,5-di-t-butyl-4-hydroxyphenyl)-propionate, stearamide-N,N-bis-[ethylene-3-(3,5-di-t-butyl-4-hydroxyphenyl)propionate], N-butylimino-N,N-bis-[ethylene-3-(3,5-di-t-butyl-4-hydroxyphenyl)propionate], 2-(2-stearoyloxyethylthio)ethyl-3,5-di-t-butyl-4-hydroxybenzoate, 2-(2-stearoyloxyethylthio)ethyl-7-(3-methyl-5-t-butyl-4-hydroxyphenyl)heptanoate, 1,2-propyleneglycol-bis-[3-(3,5-di-t-butyl-4-hydroxyphenyl)propionate], ethyleneglycol-bis-[3-(3,5-di-t-butyl-4-hydroxyphenyl)propionate], neopentylglycol-bis-[3-(3,5-di-t-butyl-4-hydroxyphenyl)propionate], ethyleneglycol-bis-(3,5-di-t-butyl-4-hydroxyphenylacetate), glycerol-1-n-octadecanoate-2,3-bis-(3,5-di-t-butyl-4-hydroxyphenylacetate), pentaerythritoltetrakis[3-(3′,5′-di-t-butyl-4′-hydroxyphenyl)propionate], 1,1,1-trimethylolethane-tris-[3-(3,5-di-t-butyl-4-hydroxyphenyl)propionate], sorbitol-hexa-[3-(3,5-di-t-butyl-4-hydroxyphenyl)propionate], 2-hydroxyethyl-7-(3-methyl-5-t-butyl-4-hydroxyphenyl)propionate, 2-stearoyloxyethyl-7-(3-methyl-5-t-butyl-4-hydroxyphenyl)heptanoate, 1,6-n-hexanediol-bis-[(3′,5′-di-butyl-4-hydroxyphenyl)propionate] and pentaerythritoltetrakis(3,5-di-t-butyl-4-hydroxyhydrocinnamate). The-above described phenolic compounds have been commercialized, for example, as “Irganox1076” and “Irganox1010” from Ciba Specialty Chemicals, Inc.

As a hindered amine compound, preferable is a compound represented by Formula (B).

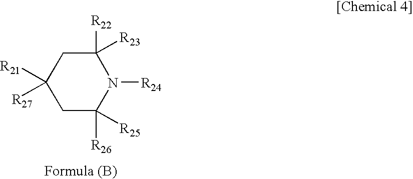

In Formula (B), R₂₁, R₂₂, R₂₃, R₂₄, R₂₅, R₂₆, and R₂₇ each represent a substituent. Examples of the substituent are common to the substituents described for Formula (A). R24 is preferably a hydrogen atom or a methyl group, R27 is preferably a hydrogen atom and R22, R23, R25 and R26 each are preferably a methyl group.

Examples of a hindered amine compound include: bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(N-octoxy-2,2,6,6-tetramethyl-4-piperidyl)sebacate, bis(N-benzyloxy-2,2,6,6-tetramethyl-4-piperidyl)sebacate, bis(N-cyclohexyloxy-2,2,6,6-tetramethyl-4-piperidyl)sebacate, bis(1,2,2,6,6-pentamethyl-4-piperidyl)-2-(3,5-di-t-butyl-4-hydroxybenzyl)-2-butylmalonate, bis(1-acroyl-2,2,6,6-tetramethyl-4-piperidyl)-2,2-bis(3,5-di-t-butyl-4-hydroxybenzyl)-2-butylmalonate, bis(1,2,2,6,6-pentamethyl-4-piperidyl)decanedioate, 2,2,6,6-tetramethyl-4-piperidylmethacrylate, 4-[3-(3,5-di-t-butyl-4-hydroxyphenyl)propionyloxy]-1-[2-(3-(3,5-di-t-butyl-4-hydroxyphenyl) propionyloxy)ethyl]-2,2,6,6-tetramethylpiperidine, 2-methyl-2-(2,2,6,6-tetramethyl-4-piperidyl)amino-N-(2,2,6,6-tetramethyl-4-piperidyl)propioneamide, tetrakis(2,2,6,6-tetramethyl-4-piperidyl)-1,2,3,4-butanetetracarboxylate and tetrakis(1,2,2,6,6-pentamethyl-4-piperidyl)-1,2,3,4-butanetetracarboxylate. Also, a polymer compound is preferable, examples of which include: N,N′,N″,N″′-tetrakis[4,6-bis-[butyl(N-methyl-2,2,6,6-tetramethylpiperidine-4-yl)amino]-triazine-2-yl]-4,7-diazadecane-1,10-diamine; a polycondensation compound of dibutylamine, 1,3,5-triazine N,N′-bis(2,2,6,6-tetramethyl-4-piperidyl)-1,6-hexamethylenediamine and N-(2,2,6,6-tetramethyl-4-piperidyl)butylamine; a polycondensation compound of dibutylamine, 1,3,5-triazine and N,N′-bis(2,2,6,6-tetramethyl-4-piperidyl)butylamine; poly[{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]; a polycondensation compound of 1,6-hexanediamine-N,N′-bis(2,2,6,6-tetramethyl-4-piperidyl) and morpholine-2,4,6-trichloro-1,3,5-triazine; a high molecular weight HALS in which plurality of piperidine rings are combined via a triazine moiety, such as poly[(6-morpholino-s-triazine-2,4-diyl)[(2,2,6,6-tetramethyl-4-piperidyl)imino]-hexamethylene [(2,2,6,6-tetramethyl-4-piperidyl)imino]]; a polymer of dimethyl succinate and 4-hydroxy-2,2,6,6-tetramethyl-1-piperidineethanol; and a compound in which a piperizine ring is combined via a ester bond, such as a mixed ester compound of 1,2,3,4-butanetetracarboxylic acid, 1,2,2,6,6-pentamethyl-4-piperizinol and 3,9-bis(2-hydroxy-1,1-dimethylethyl)-2,4,8,10-tetraoxaspiro[5,5]undecane, however, the present invention is not limited thereto. Among these compounds, preferable are, for example, a polycondensation compound of dibutylamine, 1,3,5-triazine and N,N′-bis(2,2,6,6-tetramethyl-4-piperidyl)butylamine; poly[{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]; and a polymer of dimethyl succinate and 4-hydroxy-2,2,6,6-tetramethyl-1-, which have a number average molecular weight (Mn) of 2,000-5,000.

The above-described hindered phenol compounds have been commercialized, for example, as “Tinuvin144” and “Tinuvin7700” from Ciba Specialty Chemicals, Inc.; and as “ADK STAB LA-52” from Asahi Denka Co., Ltd. Some of the compounds of the present invention are also included in the above examples, which means that the compound of the present invention are also usable as an antioxidant.

Examples of the preferable phosphorus compound in the present invention include compounds represented by Formulae (C-1), (C-2), (C-3), (C-4), and (C-5).

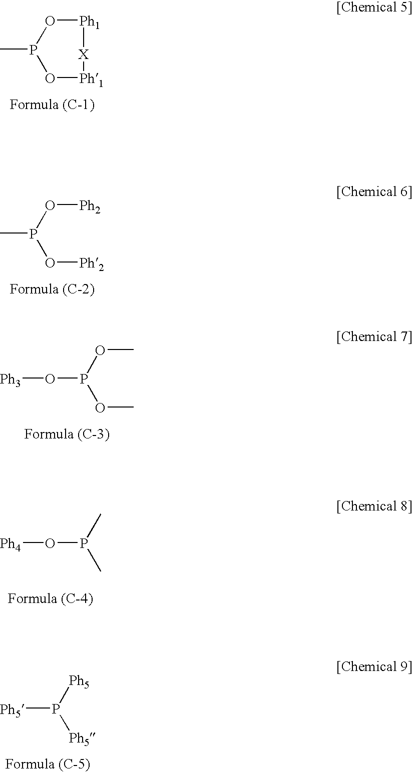

In the above Formulae (C-1), (C-2), (C-3), (C-4), and (C-5), Ph₁ and Ph′₁ each represent a substituent. Examples of the substituent are common to the substituents described for Formula (A). More preferably, Ph₁ and Ph′₁ each represent a phenylene group, and the hydrogen atom of the phenylene group may be replaced with a phenyl group, an alkyl group having 1-8 carbon atoms, a cycloalkyl group having 5-8 carbon atoms, an alkylcycloalkyl group having 6-12 carbon atoms, or an aralkyl group having 7-12 carbon atoms. Ph₁ and Ph′₁ may be mutually the same, or may be different. X represents a single bond, a sulfur atom, or a —CHR₆-group. R₆ represents a hydrogen atom, an alkyl group having 1-8 carbon atoms, or a cycloalkyl group having 5-8 carbon atoms. Further, these groups may be replaced by one of the substituents which are common to the substituents described for Formula (A). Ph₂ and Ph′₂ each represent one of the substituents which are common to the substituents described for Formula (A). More preferably, Ph₂ and Ph′₂ each represent a phenyl group or a biphenyl group. The hydrogen atom of the phenyl group or the biphenyl group may be replaced by an alkyl group having 1-8 carbon atoms, a cycloalkyl group having 5-8 carbon atoms, an alkylcycloalkyl group having 6-12 carbon atoms, or an aralkyl group having 7-12 carbon atoms. Ph₂ and Ph′₂ may be mutually the same or may be different, and Ph₂ and Ph′₂ may further be substituted with one of the substituents which are common to the substituents described for Formula (A). Ph₃ represents one of the substituents which are common to the substituents described for Formula (A). More preferably, Ph₃ represents a phenyl group or a biphenyl group. The hydrogen atom of the phenyl group or the biphenyl group may be replaced by an alkyl group having 1-8 carbon atoms, a cycloalkyl group having 5-8 carbon atoms, an alkylcycloalkyl group having 6-12 carbon atoms, or an aralkyl group having 7-12 carbon atoms. Ph₃ may further be substituted with one of the substituents which are common to the substituents described for Formula (A). Ph₄ represents one of the substituents which are common to the substituents described for Formula (A). More preferably, Ph₄ represents an alkyl group having 1-20 carbon atoms or a phenyl group. The hydrogen atom of the alkyl group or the phenyl group may be replaced with one of the substituents which are common to those described for Formula (A). Ph₅, Ph′₅, and Ph″₅ each represent one of the substituents which are common to the substituents described for Formula (A). More preferably, Ph₂ and Ph′₂ each represent an alkyl group having 1-20 carbon atoms or a phenyl group. The hydrogen atom of the alkyl group or the phenyl group may be replaced by one of the substituents which are common to the substituents described for Formula (A).

Examples of a phosphorus compound include: triphenyl phosphate; diphenylisodecyl phosphate; phenyldiisodecyl phosphate; tris(nonylphenyl)phosphate; tris(dinonylphenyl)phosphate; tris(2,4-di-t-butylphenyl)phosphite, 10-(3,5-di-t-butyl-4-hydroxybenzyl)-9,10 dihydro-9-oxa-10-phosphaphenanthrene-10-oxide; 6-[3-(3-t-butyl-4-hydroxy-5-methylphenyl)propoxy]-2,4,8,10-tetra-t-butyldibenz[d,f][1.3.2]dioxaphosphepin; a mono-phosphite compound such as tridecyl phosphate; diphosphite compounds such as 4,4′-butylidene-bis(3-methyl-6-t-butylphenyl-di-tridecyl phosphite) and 4,4′-isopropylidene-bis(phenyl-di-alkyl (C12-C15) phosphite); phosphonite compounds such as triphenyl phosphonite, tetrakis(2,4-di-tert-butylphenyl)[1,1-biphenyl]-4,4′-diylbisphosphonite and tetrakis(2,4-di-tert-butyl-5-methylphenyl)[1,1-biphenyl]-4,4′-diylbisphosphonite; phosphinite compounds such as triphenyl phosphinite and 2,6-dimethylphenyldiphenyl phosphinite; and phosphine compounds such as triphenyl phosphine and tris(2,6-dimethoxyphenyl)phosphine. Examples of above-mentioned commercially available phosphorus compounds include: “SumilizerGP” from Sumitomo Chemical Co., Ltd.; “ADK STAB PEP-24”, “ACK STAB PEP-36” and “ADK STAB 3010” from Asahi Denka Co., Ltd.; and “IRGAFOS P-EPQ” Ciba Specialty Chemicals, Inc.

As a sulfur compound, compounds represented by Formula (D) are preferable.

R₃₁—S—R₃₂ [Chemical 10]

Formula (D)

In Formula (D), R₃₁ and R₃₂ each represent one of the substituents which are common to the substituents described for Formula (A). Each of R₃₁ and R₃₂ is preferably an alkyl group.

Examples of a sulfur-containing compound include: dilauryl-3,3-thio-dipropionate, dimyristyl-3,3′-thiodipropionate, distearyl-3,3-thio-dipropionate, laurylstearyl-3,3-thio-dipropionate, pentaerythritol-tetrakis (β-lauryl-thio-propionate), 3,9-bis(2-dodecylthioethyl)-2,4,8,10-tetra-oxaspiro[5,5]undecane. The above sulfur-containing compounds have been commercialized, for example, as “Sumilezer TPL-R” and “Sumilezer TP-D” from Sumitomo Chemical Co., Ltd.

As for an antioxidant, similarly to the foregoing cellulose resin, preferably removed is the impurity such as a residual acid, an inorganic salt or an organic low molecular weight compound which may be incorporated in the production process or during storage. The purity of an antioxidant is preferably at least 99%, and the contents of residual acid and impurity water are preferably 0.01 to 100 ppm, whereby, in the melt cast process of the cellulose ester, deterioration via heat can be reduced, and film-production stability, the optical property and the physical property of the film are also improved.

### (Acid Scavenger)

The acid scavenger is an agent that has the role of trapping the acid (proton acid) remaining in the cellulose ester that is brought in during production. The side chain hydrolysis is also promoted with water in a polymer and heat by melting cellulose ester, and in the case of CAP, acetic acid or propionic acid is formed. The acid scavenger may be able to chemically bond with acid, and examples thereof include compounds including epoxy, tertiary amines, and ether structures, but the present invention is not limited thereto.

Specific examples include epoxy compounds as acid scavengers described in the specification of U.S. Pat. No. 4,137,201. The epoxy compounds as acid scavengers include those known in the technological field, and examples include polyglycols derived by condensation such as diglyceril ethers of various polygycols, especially those having approximately 8-40 moles of ethylene oxide per mole of polyglycol, diglyceril ethers of glycerol and the like, metal epoxy compounds (such as those used in the past in vinyl chloride polymer compositions and those used together with vinyl chloride polymer compositions), epoxy ether condensation products, a diglycidyl ether of bisphenol A (namely 2,2-bis(4-glycidyloxyphenyl)propane), epoxy unsaturated fatty acid esters (particularly alkyl esters having about 4-2 carbon atoms of fatty acids having 2-22 carbon atoms (such as butyl epoxy stearate) and the like, and various epoxy long-chain fatty acid triglycerides and the like (such as epoxy plant oils which are typically compositions of epoxy soy bean oil and the like and other unsaturated natural oils (these are sometimes called epoxyified natural glycerides or unsaturated fatty acids and these fatty acids generally have 12 to 22 carbon atoms)). Particularly preferable are commercially available epoxy resin compounds, which include an epoxy group such as EPON 815c, and other epoxyified ether oligomer condensates such as those represented by the Formula (1).

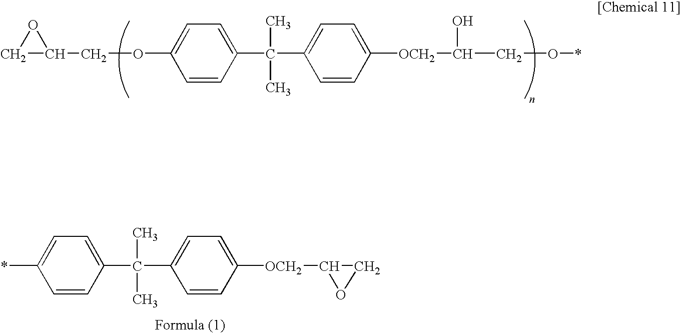

In the above-described formula, n is equal to 0-12. Other usable examples of the acid scavenger include those described in paragraphs 87-105 in Japanese Patent O.P.I. Publication No. 5-194788.

### (UV Absorbent)

The UV absorbent preferably has excellent ultraviolet light absorbance in a wavelength of 370 nm or less in view of preventing deterioration of a polarizer or a display device against ultraviolet light, and it is preferable that there is little absorbance of visible light in a wavelength of not at least 400 nm from the viewpoint of a liquid crystal display property. Examples of the UV absorbent include oxybenzophenone compounds, benzotriazole compounds, salicylic acid ester compounds, benzophenone compounds, cyano acrylate compounds nickel complex compounds and the like and benzophenone compounds as well as benzotriazole compounds which have little coloration are preferable. In addition, the UV absorbents described in Japanese Patent O.P.I. Publication Nos. 10-182621 and 8-337574, and the high molecular weight UV absorbents described in Japanese Patent O.P.I. Publication No. 6-148430 may also be used.

Specific examples of the benzotriazole based UV absorbents include 2-(2′-hydroxy-5′ methylphenyl)benzotriazole, 2-(2′-hydroxy 3′,5′-di-tert-butyl phenyl)benzotriazole, 2-(2′-hydroxy 3′-tert-butyl-5′-methylphenyl)benzotriazole, 2-(2′-hydroxy 3′,5′-di-tert-butyl phenyl)-5-chlorobenzotriazole, 2-(2′-hydroxy 3′-(3″,4″,5″,6″-tetrahydrophthalimide methyl)-5′-methylphenyl)benzotriazole, 2,2-methyl bis(4-(1,1,3,3,-tetramethyl butyl)-6-(2H-benzotriazole-2-yl)phenyl), 2-(2′-hydroxy-3′-tert-butyl-5′-methylphenyl)-5-chlorobenzotriazole, 2-(2H-benzotriazole-2-yl)-6-(straight chain or side chain dodecyl)-4-methylphenyl, and mixtures of octyl-3-[3-tert-butyl-4-hydroxy-5-(chloro-2H-benzotriazole-2-yl)phenyl]propionate and 2-ethylhexyl-3-[3-tert-butyl-4-hydroxy-5-(5-chloro-2H-benzotriazole-2-yl)phenyl]propionate, but the present invention is not limited thereto.

Commercially available TINUVIN 109, TINUVIN 171, and TINUVIN 360 manufactured by Chiba Specialty Chemical Co., Ltd. may also be used as the benzotriazole based UV absorbent.

Examples of the benzophenone based compound include 2,4-hydroxy benzophenone, 2,2′-dihydroxy-4-methoxy benzophenone, 2-hydroxy-4-methoxy-5-sulfobenzophenone, bis (2-methoxy-4-hydroxy-5-benzoyl phenyl methane) and the like, but the present invention is not limited thereto.

The amount of the UV absorbent used in the present invention is preferably 0.1-20% by weight, and more preferably 0.5-10% by weight, and still more preferably 1-5% by weight. Two or more of these may be used in combination.

### (Matting Agent)

Particles such as a matting agent or the like may be added into a cellulose ester film of the present invention in order to provide smoothness, and particles of inorganic compounds as well as particles of organic compounds may be used. The matting agent should be as fine particle as possible, and examples of the particle include inorganic particles such as those of silicon dioxide, titanium dioxide, aluminum oxide, zirconium oxide, calcium carbonate, kaolin, talc, burned calcium silicate, hydrated calcium silicate, aluminum silicate, magnesium silicate, and calcium phosphate or cross-linked particles of high molecular weigh polymers of these. Of these, silicon dioxide is preferable in view of reduced haze in a film. Particles such as silicon dioxide particles are often surface treated with an organic substance, but it is preferable that haze in the film can be reduced.

Examples of organic compounds preferably employed for surface treatment include halogens, alkoxysilanes, silazanes, and siloxanes. Particles having a larger average particle diameter have a greater matting effect, while particles having a smaller average particle diameter have excellent transparency. The secondary particles should have an average primary particle diameter in the range of 0.05˜1.0 μm. The secondary particles preferably have an average primary particle diameter in the range of 5 to 50 nm, and more preferably 7 to 14 nm. These particles are preferable because they create unevenness of 0.01 to 1.0 μm in the plane of the cellulose ester film. The content of particles included in cellulose ester is preferably 0.005-0.3% by weight, based on that of cellulose ester.

Examples of silicon dioxide particles include Aerosil 200, 200V, 300, R972, R972V, R974, R202, R812, OX50, or TT600 each manufactured by Nippon Aerosil Co., Ltd., and of these, Aerosil 200V, R972, R972V, R974, R202, and R812, are preferable. Two or more of these matting agents may be used in combination. In the case of using two or more matting agents, they may be mixed in any content ratio. In this case, matting agents having a different particle diameter and quality, for example, Aerosil 200V and R972V may be used in the content range of 0.1:99.9-99.9:0.1.

The presence of particles used as the above-described matting agent in a film can also be utilized for another purpose to improve strength of the film. The presence of the above-described particles in the film is also possible to improve the orientation of cellulose ester itself constituting an optical film of the present invention.

### (Retardation Regulator)

In an optical film of the present invention, the orientation film is formed and a liquid crystal layer is provided thereon. Optical compensation capability is imparted by combining retardations originated from an optical film and a liquid crystal layer, and the polarizing plate processing may be conducted to improve quality of the liquid crystal display. Compounds added to regulate retardation include aromatic compounds having two or more aromatic rings described in the specification European Patent No. 911,656A2 which are usable as retardation regulators. Two or more of these compounds may be used in combination. The aromatic ring of the aromatic compounds may include aromatic heterocyclic rings in addition to aromatic hydrocarbon rings. The aromatic heterocyclic ring is preferable and the aromatic heterocyclic ring is generally an unsaturated heterocyclic ring. Of these, 1,3,5-triazine ring is specifically preferable.

### (Dimensional Stability)

As to an optical film of the present invention, a dimensional variation value is preferably less than ±1.0% at 80° C. and 90% RH, when based on the dimension of a film standing for 24 hours at 23° C. and 55% RH, but more preferably less than 0.5% and most preferably less than 0.1%.

Regarding the optical film of the present invention, used as a protective film for a polarizing plate, if the variation in the optical film itself exceeds the above-described range of dimensional stability, the absolute value of the retardation and the orientation angle of the polarizing plate will differ from that of the initial setting, resulting in reduced capacity for improvement in display quality, or deterioration of display quality.

### (Material Constituting Film)

The presence of additives in the materials constituting a film, such as the cellulose ester, plasticizer, antioxidant and others such as a UV absorbent, a matting agent and a retardation regulator which are added if desired, is favorable in view of preventing or controlling change in quality and deterioration of at least one of the materials constituting the film.

Volatile components generated when the materials constituting the film are melted have a content of at most 1% by weight, preferably a content of at most 0.5% by weight, more preferably a content of at most 0.2% by weight and still more preferably a content of at most 0.1% by weight. In the present invention, the differential thermal analysis-weight measurement from 30° C. to 350° C. is carried out employing a commercially available differential thermal analysis-weight analyzer, TG/DTA 200 (manufactured by Seiko Instruments Inc.), and this amount is used as the content of volatile components.

### (Stretching Operation and Refractive Index Control)

The refractive index of an optical film of the present invention may be controlled via stretching operation. When the stretching is performed by a factor of 1.0-2.0 in one direction of cellulose ester, and by a factor of 1.01-2.5 in a direction perpendicular to the foregoing direction in in-plane of the film, the refractive index can be adjusted to be set to the desired range.

For example, stretching can be done sequentially or simultaneously in the longitudinal direction of a film and in the direction perpendicular to that direction in in-plane of the film, or in other words, in the width direction. When the stretching factor in at least one direction is too small in this case, an insufficient phase difference is obtained, and when it is too large, the stretching is difficult to be conducted and breakage is sometimes generated.

For example, in the case of stretching in the direction of melt casting, when contraction in the width direction is too large, the refractive index in the thickness direction becomes too large. In this case, correction can be made by controlling the contraction in the width direction or by stretching in the width direction. In the case of stretching in the width direction, distribution of the refractive index in the width is sometimes generated. This is sometimes seen when the tenter method is employed, but a phenomenon called the bowing phenomenon appears since a contraction force is generated in the middle portion of the film by stretching in the width direction, and the end portions are fixed. Also in this case, the bowing phenomenon can be controlled by stretching in the direction of casting, and distribution of phase difference in the width direction can be made smaller to make correction.

Furthermore, by stretching the film in the biaxial directions being at right angles to each other, variation in film thickness can be reduced. When the variation in the thickness of an optical film is too large, there appears unevenness in phase difference and this causes a problem such as unevenness in coloration when applying for a liquid crystal display.

The variation in thickness of a cellulose ester film support is preferably in the range of ±3%, and more preferably ±1%. A method of extrusion in the biaxial directions being at right angles to each other is effective in the case of the objective as described above, and the stretching is performed in such a way that the final stretch factor in the biaxial directions being at right angles to each other is preferably in the range of 1.0-2.0 in the casting direction and 1.01-2.5 in the width direction, and also preferably 1.01-1.5 in the casting direction and 1.05-2.0 in the width direction.

In the case of using cellulose ester acquiring positive birefringence with respect to stress, a slow axis for an optical film can be provided in the width direction by stretching in the width direction. In this case, it is preferable that the slow axis of the optical film is in the width direction in order to improve display quality of the present invention, and it has to be satisfied that a stretching factor in the width direction is greater than a stretching factor in the casting direction.

The method for stretching a web is not specifically limited. Examples thereof include, a method of stretching in the vertical direction in which each of a plurality of rolls has a different peripheral speed and the difference in peripheral speed between the rolls is utilized; a method in which both ends of the web are fixed with clips or pins and the spaces between the pins or clips are extended in the forward direction to thereby carry out stretching in both the vertical and horizontal directions; a method in which widening in the width direction and stretching in the width direction are performed simultaneously; and a method in which widening in the vertical direction and stretching in the vertical direction are performed simultaneously. As a matter of course, these methods may be used in combination. In addition, in the case of the so-called tenter method, smooth stretching can be carried out by driving the clip portion using a linear driving method, and this method is favorable because of reduction of danger such as breakage and so forth.

Holding of the width or stretching in the longitudinal direction in the film formation process is preferably carried out employing a tenter, and may also be conducted employing a pin tenter or a clip tenter.

In the case of using an optical film of the present invention as a polarizing plate protective film, the thickness of the protective film is preferably 10-500 μm. Specifically, a thickness of at least 20 μm is preferable and a thickness of at least 35 μm is more preferable. Further, a thickness of at most 150 μm is preferable and a thickness of at most 120 μm is more preferable. Particularly favorable is a thickness of 25-90 μm. When the optical film is thicker than the above range, a polarizing plate becomes too thick after polarizing plate processing, and it is not suitable for liquid crystal displays installed in notebook type personal computers and mobile electronic devices of thin-model together with lightweight. On the other hand, when the optical film is thinner than the above-described range, generation of retardation is to be difficult, and it is not preferable that ability of the film to protect the polarizing plate against humidity is reduced since moisture permeability of a film becomes high.

The slow axis or the fast axis of an optical film of the present invention are in-plane of the film, and given that the angle formed in the direction of film formation is θ1, θ1 is preferably between −1° and +1°, and more preferably between −0.5° and +0.5°. θ1 can be defined as an orientation angle and can be measured using the automatic birefringence analyzer KOBRA-21ADH (manufactured by Oji Scientific Instruments).

When θ1 satisfies the above-described relationship, the display image can obtain high luminance, whereby this contributes to the suppression or prevention of light leakage and contributes also to precise color reproduction in the case of color liquid crystal display devices.

### (Polymer Material)

Polymer materials and oligomers other than cellulose ester may be suitably selected and mixed for an optical film of the present invention. The above-described polymer materials and oligomers preferably have excellent compatibility with cellulose ester and transmission of a formed film is preferably at least 80%, more preferably at least 90% and still more preferably at least 92%. An objective of mixing at least one of polymer materials and oligomers other than cellulose ester is associated with controlling of viscosity during heat melting and improving of physical properties of the film after film processing. In this case, additives other than those described above may be added.

### (Film Formation)

For example, a mixture of cellulose ester and additives of the present invention is subjected to hot air drying or vacuum drying, subsequently subjected to melt extrusion, and then extruded in the form of a film employing a T-type die. The film is closely brought into contact with a cooling drum using an electrostatic printing method and cold fixing is conducted to obtain an unstretched film. The temperature of the cooling drum is preferably maintained at 90-150° C.

The melt extrusion may be conducted employing a uniaxial extruder, a biaxial extruder or a biaxial extruder connected to a uniaxial extruder downstream thereof, but it is preferable that the uniaxial extruder is used in view of mechanical strength and optical properties of the resulting film. It is also preferable that in a supplying process to the raw material tank, the raw material charge section and the extruder interior as well as a melting process, the ambient air is replaced by an inert gas such as nitrogen or the like, or the ambient air pressure is reduced.

The temperature during the foregoing melt extrusion of the present invention is conventionally in the range of 150-300° C., more preferably 180-270° C., but still more preferably 200-250° C.

It is particularly preferable that in the case of preparing a polarizing plate as a polarizing plate protective film for an optical film of the present invention, a cellulose ester film is formed by stretching in the width direction or in the longitudinal direction.

The film is preferably peeled off the foregoing cooling drum and the resulting unstretched film is heated in the range from glass transition temperature (Tg) of cellulose ester to Tg+100° C. by a heating device equipped with a plurality of heated rollers and/or infrared ray heaters, and stretched in a single or a plurality of steps. Next, the cellulose ester film stretched in the longitudinal direction as described above is preferably also stretched in the lateral direction in the range of Tg to Tg−20° C., after which the heat-fixing is conducted.

In the case of lateral stretching, when the stretching is conducted while sequentially heating the film at a stretching zone divided into at least two zones having a temperature difference of 1-50° C., distribution of physical properties in the width direction is preferably reduced. Further, when the film is maintained at not more than the final lateral stretching temperature and at not less than Tg-40° C. for 0.01-5 minutes after lateral stretching, the distribution of physical properties in the width direction is preferably further reduced.

Heat-fixing is conventionally conducted at a higher temperature than the final lateral stretching temperature and at not more than Tg-20° C. for 0.5-300 seconds. In this case, it is preferable that heat-fixing is conducted while sequentially increasing temperature in a stretching zone divided into at least two zones having a temperature difference in the range of 1-100° C.

The film which has been subjected to heat-fixing is usually cooled to a temperature less than the Tg, and the clip holding portion at both ends of the film is cut off to wind up the film. In this case, it is preferable that a 0.1-10% relaxing process is conducted in at least one of the lateral and longitudinal directions at not more than the final heat-fixing temperature and at not less than the Tg. Slow cooling is also preferably conducted at a cooling rate of at most 100° C. per second from the final heat-fixing temperature to the Tg. The means for the slow cooling process is not specifically limited, and can be conducted by a commonly known means, but it is particularly preferable to conduct these processes while sequentially cooling in a plurality of temperature zones in view of improving dimensional stability of the film. It is given that the final fixing temperature is set to T1 and time to reach Tg from the final heat-fixing temperature is set to “L”, the cooling rate is determined by (T1−Tg)/t.

The optimal conditions of heat-fixing, cooling, and slow cooling processes depend on cellulose ester constituting the film, and thus are determined by measuring the physical properties of the biaxially stretched film, and by suitably adjusting the conditions to as to obtain favorable properties.

### (Functional Layers)

When an optical film of the present invention is formed, functional layers such as an antistatic layer, a hard coat layer, an anti-reflection layer, a matting layer, an adhesive layer, an anti-glare layer, a barrier layer and an optical compensation layer may be coated before and/or after stretching. It is preferred to provide at least one layer selected from an anti-static layer, a hard coat layer, an anti-reflection layer, an adhesive layer, an antiglare layer and an optical compensation layer. In this case, various surface treatments such as a corona discharge treatment, a plasma treatment and a chemical treatment may also be carried out, if desired.

An optical film of the present invention preferably exhibits high visible light transmission, and a YI value via methods specified by JIS-Z-8701 and Z-8722 other than the transmission measurement is utilized for quantitative determination. This value becomes larger while increasing the thickness, but in the case of using a film having a thickness of 80 μm, the value is preferably 0.01-2.0, more preferably 0.05-1.5, and still more preferably 0.1-1.2.

In the present invention, a laminated cellulose ester film may be formed by co-extruding cellulose ester compositions containing different kinds of cellulose esters, different kinds of additives or different contents of additives.

For example, a cellulose ester film can be prepared so as to have a structure of a skin layer/core layer/skin layer. Particles such as a matting agent may be largely introduced in the skin layer quite, and may be only in the skin layer. A melt extrusion layer of diacetyl cellulose which can be easily saponified may be formed as a skin layer. The melt extrusion of diacetyl cellulose can be carried out employing a known method in the art. A low volatility plasticizer and/or a UV absorbent may be added into a skin layer, while a plasticizer exhibiting excellent plasticity or a UV absorbent exhibiting an excellent ultraviolet light absorbing property may be added to the core layer. The Tg of the skin layer and the core layer may be allowed to be different, and the Tg of the core layer may be lower than that of the skin layer. Further, the viscosity of the melt including the cellulose ester during melt casting may differ in the skin layer and the core layer, and the viscosity of the skin layer may be larger than the viscosity of the core layer, or the viscosity of the core layer may be larger than or equal to the viscosity of a skin layer. A laminated film having uniform thickness can be obtained when the melt of a thinner layer (conventionally a skin layer) has higher viscosity.

### (Polarizing Plate)

In the case of using a cellulose ester film of the present invention as a polarizing plate protective film utilized for a liquid crystal display after forming a polarizing plate, a polarizing plate provided on at least one side is preferably the polarizing plate of the present invention, and polarizing plates provided on both sides are more preferably the polarizing plates of the present invention.

As a conventional polarizing plate protective film, employed have been cellulose ester films of Konica Minolta TAC: KC8UX, KC4UX, KC5UX, KC8UY, KC4UY, KC8UCR-3, KC8UCR-4, KC12UR, KC8UXW-H, KC8UYW-HA, and KC8UX-RHA (produced by Konica Minolta Opto, Inc.).

A method of preparing a polarizing plate of the present invention is not specifically limited, and commonly known methods are applicable. The resulting polarizing plate protective film of the present invention may be treated with an alkali solution and adhered onto both surfaces of a polarizer using an aqueous solution of fully saponified polyvinyl alcohol. The polarizer can be prepared by immersing a polyvinyl alcohol film in an aqueous solution containing iodine while stretching. This method is favorable because the polarizing plate protective film of the present invention can be directly adhered onto at least one surface of the polarizer.

In place of the above-described alkali treatment, an adhesion treatment, for example, disclosed in Japanese Patent O.P.I. Publication Nos. 6-94915 and 6-118232 may be carried out.

A polarizing plate is composed of a polarizer film and protective films which protect the both surfaces of the polarizer. It is also possible to constitute a polarizing plate by attaching a protective film onto one surface of the polarizing plate and a separate film on the reverse surface of the polarizing plate. The protective film and the separate film are employed to protect the polarizing plate during its shipping and product inspection. In this case, the protective film is attached in order to protect the surface of the polarizing plate, and used on the reverse surface side of the surface on which the polarizing plate is attached to a liquid crystal cell. On the other hand, the separate film is used in order to cover the adhesion layer.

### (Liquid Crystal Display)

A substrate containing a liquid crystal cell is usually placed between two polarizing plates in a liquid crystal display device. Since s polarizing plate protective film to which an optical film of the present invention is applied exhibits high dimensional stability, an excellent display performance can be obtained even though the polarizing plate of the present invention is placed in any portion of the liquid crystal display. On an outermost surface from the viewer side of a liquid crystal display, a polarizing plate protective film is preferably provided with a clear hard coat layer, an antistatic layer and an antireflection layer. When a polarizing plate protective film is provided with an optical compensation layer, or a film itself has a function of optical compensation, an excellent display performance is obtained by placing the polarizing plate protective film at the portion brought in contact with a liquid crystal cell. The effect of the present invention can be markedly produced by utilizing the polarizing plate protective film of the present invention in a multi-domain mode liquid crystal display, but more preferably in a multi-domain mode liquid crystal display in a birefringence mode.

The multi-domain mode refers to a method in which a pixel is divided into plural domains, which is suitable for improving viewing angle dependency of images and symmetry of image displaying. On this mode, various methods have been reported, for example, in “Okita and Yamauchi, Liquid Crystal, 6(3), p 303 (2002)”; and, on multi-domain mode liquid crystal display, for example, in “Yamada and Yamahara, LIQUID CRYSTAL, 7(2), p 184 (2003)”, however, the present invention is not limited thereto.

The display quality is preferably symmetrical in the case of observations by a viewer. Accordingly, when the display is a liquid crystal display, multi-domaining of pixels can be done in order to improve the symmetry on the viewing side of the display. The method of multi-domaining can be selected from those known in the art in consideration of a characteristic of liquid crystal mode via binary dividing or preferably quaternary dividing of the pixel.

A polarizing plate of the present invention may be effectively utilized in the following modes, for example: a MVA (Multi-domain Vertical Alignment) mode which is one of typical examples of the vertical alignment mode, specifically a 4-domain MVA mode; a PVA (Patterned Vertical Alignment) mode which is multi-domained by patterned electrodes; and a CPA (Continuous Pinwheel Alignment) mode in which a Chiral force and patterned electrodes are merged. Use of an optically biaxial film in an OCB (Optically Compensated Bend) mode has been disclosed in “T. Miyashita, T. Uchida, J. SID, 3(1), 29 (1995)”, in which as to display quality, the polarizing plate of the present invention is also possible to produce effects of the present invention. The liquid crystal mode and the polarizing plate placement are not limited, provided that effects of the present invention are produced by employing the polarizing plate of the present invention.

Since the liquid crystal display device exhibits high performance as a device for displaying color images and motion pictures, the liquid crystal display fitted with an optical film of the present invention, specifically in terms of display quality of a large-screen liquid crystal display is possible to provide displaying of precise motion pictures with no tired eyes

### EXAMPLE

Next, the present invention will be described in detail referring to examples, but the present invention is not limited thereto. Incidentally, “parts” in the following description represents “parts by weight”

### Example 1

### Preparation of Cellulose Ester Film

Cellulose ester C-1 (CAP-482-20 manufactured by Eastman Chemical Co.) was dried in air at 130° C. at ambient pressure for 2 hours, and then cooled to room temperature. Into this cellulose ester, 1.0 part by weight of trimethylolpropanebenzoate (Chemical 16) and 0.5 parts by weight of compound 1 of the present invention were added with respect to the cellulose ester, and the resulting mixture was melted by heat to a melting temperature of 230° C. Subsequently, the melt was extruded and molded with a T die, and further, the resulting film was stretched at a stretching ratio of 1.2×1.2 at 160° C. to obtain a cellulose ester film having a thickness of 80 μm (Sample No. 1-1). The water content of cellulose ester was determined by a heat-drying type MOISTURE ANALYZER MX-50 manufactured by A&D Co., Ltd.

Each of cellulose ester films of Inventive sample Nos. 1-2-1-5 and 1-8-1-19, and Comparative sample Nos. 1-6 and 1-7 (each having a thickness of 80 μm) was prepared similarly to Sample No. 1-1, except that the kind of cellulose ester, the water content, the kind of additives and the addition amount were replaced by those described in Table 1.

TABLE 1

| | | | | Addition | | Addition | |
|---|---|---|---|---|---|---|---|
| | | Water | | amount | | amount | |
| | Cellu- | Content | | (parts | | (parts | |
| Sample | lose | (% by | | by | | by | |
| No. | ester | weight) | Plasticizer | weight) | Compound | weight) | Remarks |
| 1-1 | C-1 | 1.0 | Chemical 16 | 1 | Compound 1 | 0.5 | Inv. |
| 1-2 | C-1 | 1.0 | Chemical 16 | 5 | Compound 1 | 0.5 | Inv. |
| 1-3 | C-1 | 1.0 | Chemical 16 | 30 | Compound 1 | 0.5 | Inv. |
| 1-4 | C-1 | 1.0 | Chemical 16 | 0.5 | Compound 1 | 0.5 | Inv. |
| 1-5 | C-1 | 1.0 | Chemical 16 | 50 | Compound 1 | 0.5 | Inv. |
| 1-6 | C-1 | 1.0 | Chemical 16 | 5 | Comparative | 0.5 | Comp. |
| | | | | | Compound 1 | | |
| 1-7 | C-1 | 1.0 | Comparative | 5 | Comparative | 0.5 | Comp. |
| | | | Compound 2 | | Compound 1 | | |
| 1-8 | C-1 | 1.0 | *1 | 5 | Compound 1 | 0.01 | Inv. |
| 1-9 | C-1 | 1.0 | *1 | 5 | Compound 1 | 0.5 | Inv. |
| 1-10 | C-1 | 1.0 | *1 | 5 | Compound 1 | 5 | Inv. |
| 1-11 | C-1 | 1.0 | *1 | 5 | Compound 1 | 0.005 | Inv. |
| 1-12 | C-1 | 1.0 | *1 | 5 | Compound 1 | 10 | Inv. |
| 1-13 | C-1 | 1.0 | Chemical 12 | 5 | Compound 2 | 0.5 | Inv. |
| 1-14 | C-1 | 3.0 | Chemical 12 | 5 | Compound 2 | 0.5 | Inv. |
| 1-15 | C-1 | 5.0 | Chemical 12 | 5 | Compound 2 | 0.5 | Inv. |
| 1-16 | C-1 | 1.0 | *2 | 8 | Compound 1 | 0.5 | Inv. |
| 1-17 | C-1 | 1.0 | *3 | 8 | Compound 1 | 0.5 | Inv. |
| 1-18 | C-2 | 1.0 | Chemical 12 | 8 | Compound 1 | 0.5 | Inv. |
| 1-19 | C-2 | 1.0 | Chemical 16 | 8 | Compound 2 | 0.5 | Inv. |

Inv.: Inventive sample,
Comp.: Comparative sample
*1: Pentaerythritoltetrabenzoate,
*2: Di-2-ethylhexyladipate
*3: Dioctylsebacate
[Chemical 12]
Pentaerythritoltetrabenzoate

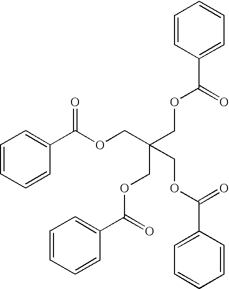

Chemical 12

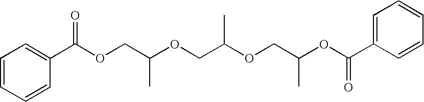

Chemical 16

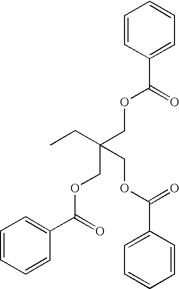

Di2-ethylhexyladipate

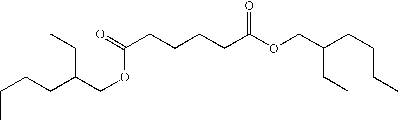

Dioctylsebacate

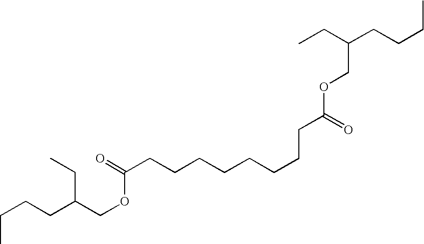

[Chemical 13]
Comparative compound 1

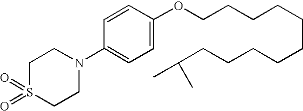

C-1: Cellulose acetate propionate CAP482-20
(manufactured by Eastman Chemical Co.)
C-2: Cellulose acetate butyrate CAB171-15
(manufactured by Eastman Chemical Co.)

Comparative Compound 2: Pinecrystal R85 (Hydrogenated Rosin, Manufactured by Arakawa Chemical Industries, Ltd.)

Inventive samples Nos. 1-1-1-5 and 1-8-1-19, and Comparative samples Nos. 1-6 and 1-7 were evaluated as described below. The results are shown in Table 2.

### [Evaluation]

### (Coefficient of Variation (CV) of Retardation Values)

Variation of retardation in the width direction was designated as coefficient of variation (CV). As for measurement of retardation values, birefringent index was measured at a wavelength of 590 nm under an atmosphere of 23° C. and 55% RH at points of every 1 cm in the width direction of the film to measure 3 times at each point employing an automatic birefringence meter KOBRA-21ADH manufactured by Oji Scientific Instruments, and Ro and Rt represented by the following equations were obtained. Coefficient of variation (CV) was obtained by assigning measured values to the following equations.

Ro=(nx−ny)×d

Rt={(nx+ny)/2−nz}×d

In the above equations, nx is the maximum in-plane refractive index (referred to also as a refractive index in the slow axis direction), ny is an in-plane refractive index in the direction perpendicular to the slow axis direction, nz is a refractive index in the thickness direction, and d is a film thickness in nm. The standard deviation was calculated using a (n-1) method.

Coefficient of variation(CV)=(Standard deviation)/(Average Retardation Value)

A: CV is less than 1.5%.

B: CV is 1.5% or more but less than 5%.

C: CV is 5% or more but less than 10%.

D: CV is 10% or more.

### (Haze)

Results obtained by a haze meter (1001 DP model manufactured by Nippon Denshoku Industries Co., Ltd.) were converted to haze values in the case of a sample having a thickness of 80 μm. The criteria for the evaluation are as follows:

A: Haze was less than 0.5%

B: Haze was 0.5% or more but less than 1.0%.

C: Haze was 1.0% or more but less than 1.5%.

D: Haze was 1.5% or more but less than 2.0%.

E: Haze was 2.0% or more.

### (Measurement of Luminescent Foreign Material)

Two polarizing plates were placed in a crossed Nicol state to block light transmission, and each sample was inserted between the two polarizing plates. Polarizing plates having a glass protective plate were used. Light was irradiated on one side of the sample and the number of luminescent points having a diameter of 0.01 mm or more per 1 cm² were counted from the opposite side using an optical microscope (magnification of 50 times). The criteria for the evaluation are as follows:

A: The number of luminescent points is 0-30.

B: The number of luminescent points is 31-50.

C: The number of luminescent points is 51-80.

D: The number of luminescent points is 81-100.

E: The number of luminescent points is 101 or more.

### (Color)

In the present invention, yellow index of a film (YI value) was calculated as described below. Transmission of a molded film with respect to visual light (380-780 nm) was measured under a C light source employing a spectrophotometer U-3310 (manufactured by Hitachi High-Technologies Corporation) according to a method specified by JIS-Z-8701 and Z-8722 to calculate spectral tristimulus values of X, Y and Z, and yellow index (YI value). The criteria for the evaluation are as follows:

A: YI value is 0.1 or more but less than 1.2.

B: YI value is 1.2 or more but less than 2.0.

C: YI value is 2.0 or more but less than 5.0.

TABLE 2

| | Coefficient of | | Luminescent | | |
|---|---|---|---|---|---|
| Sample | variation | | foreign | | |
| No. | (CV) | Haze | material | Color | Remarks |
| 1-1 | B | B | B | A | Inv. |
| 1-2 | A | A | A | A | Inv. |
| 1-3 | B | A | B | B | Inv. |
| 1-4 | C | C | C | A | Inv. |
| 1-5 | C | C | B | B | Inv. |
| 1-6 | D | E | D | C | Comp. |
| 1-7 | D | D | E | C | Comp. |
| 1-8 | B | B | B | A | Inv. |
| 1-9 | A | B | A | A | Inv. |
| 1-10 | A | A | A | A | Inv. |
| 1-11 | C | C | C | B | Inv. |
| 1-12 | C | B | C | B | Inv. |
| 1-13 | A | B | B | A | Inv. |
| 1-14 | B | A | B | A | Inv. |
| 1-15 | C | C | C | A | Inv. |
| 1-16 | A | B | B | A | Inv. |
| 1-17 | B | A | B | A | Inv. |
| 1-18 | B | B | A | A | Inv. |
| 1-19 | B | A | A | A | Inv. |

Inv.: Inventive sample,
Comp.: Comparative sample

As is clear from the above table, it is to be understood that Inventive samples Nos. 1-1-1-5 and 1-8-1-19 exhibit excellent optical properties such as coefficient of variation of retardation, haze and luminescent foreign material in comparison to those of Comparative samples samples Nos. 1-6 and 1-7.

[Preparation of coating composition]

| (Antistatic layer coating composition (1)) | | |
|---|---|---|
| Polymethyl metacrylate (weight average | 0.5 | parts |
| molecular weight: 550,000; Tg: 90° C.) | | |
| Propylene glycol monomethyl ether | 60 | parts |
| Methylethyl ketone | 16 | parts |
| Ethyl lactate | 5 | parts |
| Methanol | 8 | parts |
| Conductive polymer resin P-1 (particles | 0.5 | parts |
| having a size of 0.1-0.3 μm diameter) | | |
| [Chemical 14] | | |
| Conductive polymer resin P-1 | | |
| 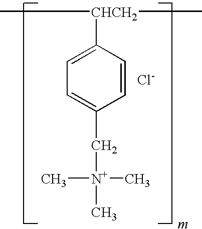 | | |
| 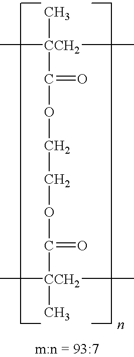 | | |
| (Hard coat layer coating composition (2)) | | |
| Dipentaerythritol hexaacrylate monomer | 60 | parts |
| Dipentaerythritol hexaacrylate dimer | 20 | parts |
| Components of at least dipentaerythritol | 20 | parts |
| hexaacrylate trimer | | |
| Diethoxybenzophenone photoreaction | 6 | parts |
| initiator | | |
| Silicone surfactant | 1 | part |
| Propylene glycol monomethyl ether | 75 | parts |
| Methyl ethyl ketone | 75 | parts |
| (Anti-curl layer coating composition (3)) | | |
| Acetone | 35 | parts |
| Ethyl acetate | 45 | parts |
| Isopropyl alcohol | 5 | parts |
| Diacetyl cellulose | 0.5 | part |

Ultrafine particles of silica 2% acetone dispersion (Aerosil 200V produced by Nippon Aerosil Co., Ltd.) 0.1 parts

Functional polarizing plate protective films are prepared as described below.

### [Polarizing Plate Protective Film]

An anti-curl layer coating composition (3) was gravure-coated so as to give a wet coat thickness of 13 μm on one surface of optical film sample No. 1-21 prepared similarly to Sample 1-1, except that stretching ratios were 1.2 in the longitudinal direction and 2.0 in the lateral direction, and then dried at a drying temperature of 80±5° C. This was designated as optical film sample No. 1-21A. Next, an antistatic layer coating composition (1) was coated on the other surface of this cellulose ester film at 28° C. and 82% RH at film conveyance speed of 30 m/min so as to give a wet coat thickness of 7 μm and a coating width of 1 m, and then dried at the drying section adjusted to 80±5° C. to obtain a resin layer having a dry thickness of approximately 0.2 μm, and to obtain a cellulose ester film bearing an antistatic layer. This was designated as optical film sample No. 1-21B.

In addition, a hard coat layer coating composition (2) was coated on this antistatic layer so as to give a wet coat thickness of 13 μm, and then dried at a drying temperature of 90° C. Subsequently, ultraviolet rays were irradiated at 150 mJ/cm² and a clear hard coat layer having a dry thickness of 5 μm was provided. This was designated as optical film sample No. 1-21C.

The resulting optical film sample Nos. 1-21A, 1-21B, and 1-21C exhibited an excellent coating property with neither brushing nor cracking after drying.

Optical film samples of the present invention Nos. 1-22A, B, C to 1-25A, B, C and 1-28A, B, C to 1-39A, B, C, were prepared similarly to the above-described Optical film samples Nos. 1-21A, B, C, except that Sample of the present invention No. 1-21 was replaced by Samples of the present invention No. 1-22 to 25 and 1-28 to 39. Any of the resulting optical film samples exhibited an excellent coating property.

For comparison, the same coating method was conducted employing an optical film sample No. 1-26.

A sample on which an anti-curl layer coating composition (3) was coated was designated as sample No. 1-26A; a sample on which an antistatic layer coating composition (1) was further coated was designated as sample No. 1-26B; and a sample on which a hard coat layer coating composition (2) provided further on this antistatic layer was designated as sample No. 1-26C.

As a result, when coating was conducted at the high humidity environment condition, brushing was generated in Sample No. 1-26A. In Sample No. 1-26B, fine cracks after drying were inclined to be observed, bur in Sample 1-26C fine cracks after drying were clearly observed.

Comparative optical film samples Nos. 1-27A, B, C were prepared similarly to the above-described Comparative sample Nos. 1-26A, B, C, except that Comparative samples No. 1-26 was replaced by Comparative sample No. 1-27.

### [Preparation of Polarizing Plate]

A 120 μm thick polyvinyl alcohol film was immersed in an aqueous solution containing 1 part by weight of iodine, 2 parts by weight of potassium iodide and 4 parts by weight of boric acid, and stretched by a factor of 4 at 50° C. to obtain a polarizer.

The surfaces of Inventive sample Nos. 1-1 to 1-5 and 1-8 to 1-19, and Comparative sample Nos. 1-6 and 1-7 were subjected to alkali treatment at 40° C. for 60 seconds in 2.5 M aqueous solution of sodium hydroxide, and then washed in water and dried.

The alkali-treated surfaces of two films of each of Inventive sample Nos. 1-1 to 1-5 and 1-8 to 1-19, and Comparative sample Nos. 1-6 and 1-7 adhered to both surfaces of the above-described polarizer, employing a 5% completely saponified polyvinyl alcohol aqueous solution as an adhesive to prepare Inventive polarizing plate Nos. 1-1 to 1-5 and 1-8 to 1-19, and, Comparative polarizing plate Nos. 1-6 and 1-7 each bearing a protective film.

Inventive polarizing plate Nos. 1-1 to 1-5 and 1-8 to 1-19 exhibited excellent optical and physical properties together with an excellent polarization degree in comparison to Comparative polarizing plate Nos. 1-6 and 1-7.

### [Evaluation of Liquid Crystal Display]

The polarizing plate of a TFT color liquid display LA-1529HM (manufactured by NEC Corporation) was peeled off and each of the polarizing plates prepared above were cut to fit the size of the liquid crystal cell. Two polarizing plates of each sample prepared above adhered to the liquid cell so that the liquid crystal cell was interposed therebetween, wherein the polarizing axis of each polarizing plate was laid in the same direction as that of the original polarizing axis, while the two polarizing axes of each two polarizing plates orthogonally crossed with each other to obtain the 15-inch TFT color liquid crystal displays, and properties as the polarizing plate of cellulose ester films were evaluated. The inventive polarizing plate Nos. 1-1 to 1-5 and 1-8 to 1-19 exhibited higher contrast and an excellent display property in comparison to comparative polarizing plate Nos. 1-6 and 1-7. It was confirmed that the inventive polarizing plates are excellent as the polarizing plate for an image display device such as a liquid crystal display.

### Example 2

Similarly to Example 1, cellulose ester films having a kind of cellulose ester, a water content, a kind of additives and an addition amount as described in Table 3 were prepared. Results evaluated as above were shown in Table 4.

TABLE 3

| *3 | *4 | *5 | Plasticizer | *6 | Compound | *6 | *7 | *6 | *8 | *6 | *9 |
|---|---|---|---|---|---|---|---|---|---|---|---|
| 2-1 | C-1 | 1.0 | *1 | 1 | Compound 1 | 0.25 | P-1 | 0.25 | | | Inv. |
| 2-2 | C-1 | 1.0 | *1 | 5 | Compound 1 | 0.25 | P-1 | 0.25 | | | Inv. |
| 2-3 | C-1 | 1.0 | *1 | 30 | Compound 1 | 0.25 | P-1 | 0.25 | | | Inv. |
| 2-4 | C-1 | 1.0 | *1 | 0.5 | Compound 1 | 0.25 | P-1 | 0.25 | | | Inv. |
| 2-5 | C-1 | 1.0 | *1 | 50 | Compound 1 | 0.25 | P-1 | 0.25 | | | Inv. |
| 2-6 | C-1 | 1.0 | *1 | 5 | Comparative | 0.25 | P-1 | 0.25 | | | Comp. |
| | | | | | Compound 1 | | | | | | |
| 2-7 | C-1 | 1.0 | Comparative | 5 | Comparative | 0.25 | P-1 | 0.25 | | | Comp. |
| | | | Compound 2 | | Compound 1 | | | | | | |
| 2-8 | C-1 | 1.0 | *1 | 5 | Compound 1 | 0.25 | AO-1 | 0.25 | | | Inv. |
| 2-9 | C-1 | 1.0 | *1 | 5 | Compound 1 | 0.01 | AO-2 | 0.01 | | | Inv. |
| 2-10 | C-1 | 1.0 | *1 | 5 | Compound 1 | 0.25 | AO-2 | 0.25 | | | Inv. |
| 2-11 | C-1 | 1.0 | *1 | 5 | Compound 1 | 2.5 | AO-2 | 2.5 | | | Inv. |
| 2-12 | C-1 | 1.0 | *1 | 5 | Compound 1 | 0.002 | AO-2 | 0.002 | | | Inv. |
| 2-13 | C-1 | 1.0 | *1 | 5 | Compound 1 | 5.0 | AO-2 | 5.0 | | | Inv. |
| 2-14 | C-1 | 1.0 | Comparative | 5 | Comparative | 0.25 | AO-2 | 0.25 | | | Comp. |
| | | | Compound 2 | | Compound 1 | | | | | | |
| 2-15 | C-1 | 1.0 | *1 | 5 | Compound 1 | 0.25 | S-1 | 0.25 | | | Inv. |
| 2-16 | C-1 | 3.0 | *1 | 5 | Compound 1 | 0.25 | S-1 | 0.25 | | | Inv. |
| 2-17 | C-1 | 5.0 | *1 | 5 | Compound 1 | 0.25 | S-1 | 0.25 | | | Inv. |
| 2-18 | C-1 | 1.0 | Comparative | 5 | Comparative | 0.25 | S-1 | 0.25 | | | Comp. |
| | | | Compound 2 | | Compound 1 | | | | | | |
| 2-19 | C-1 | 1.0 | *1 | 5 | Compound 1 | 0.25 | HA-1 | 0.25 | | | Inv. |
| 2-20 | C-1 | 1.0 | *1 | 5 | Compound 1 | 0.25 | HA-2 | 0.25 | | | Inv. |
| 2-21 | C-1 | 1.0 | Comparative | 5 | Comparative | 0.25 | HA-2 | 0.25 | | | Comp. |
| | | | Compound 2 | | Compound 1 | | | | | | |
| 2-22 | C-1 | 1.0 | Chemical 16 | 5 | Compound 2 | 0.15 | P-1 | 0.15 | AO-1 | 0.15 | Inv. |
| 2-23 | C-1 | 1.0 | Chemical 16 | 5 | Compound 2 | 0.15 | AO-1 | 0.15 | HA-1 | 0.15 | Inv. |
| 2-24 | C-1 | 1.0 | Chemical 16 | 5 | Compound 2 | 0.15 | AO-2 | 0.15 | HA-2 | 0.15 | Inv. |
| 2-25 | C-1 | 1.0 | Comparative | 5 | Comparative | 0.15 | AO-2 | 0.15 | HA-2 | 0.15 | Comp. |
| | | | Compound 2 | | Compound 1 | | | | | | |
| 2-26 | C-1 | 1.0 | *2 | 5 | Comparative | 0.15 | AO-2 | 0.15 | HA-2 | 0.15 | Inv. |
| | | | | | Compound 1 | | | | | | |
| 2-27 | C-2 | 1.0 | *2 | 5 | Comparative | 0.15 | AO-2 | 0.15 | HA-2 | 0.15 | Inv. |
| | | | | | Compound 1 | | | | | | |
| 2-28 | C-2 | 1.0 | Comparative | 5 | Comparative | 0.15 | AO-2 | 0.15 | HA-2 | 0.15 | Comp. |
| | | | Compound 2 | | Compound 1 | | | | | | |

Inv.: Inventive sample,
Comp.: Comparative sample
*1: Pentaerythritoltetrabenzoate,
*2: Di-2-ethylhexyladipate
*3: Sample No.
*4: Cellulose ester
*5: Water content (% by weight)
*6: Addition amount (parts by weight)
*7: Stabilizer 1
*8: Stabilizer 2
*9: Remarks
P-1: tris(2,4-di-t-butylphenyl) phosphite
AO-1: octadecyl-3-(3,5-di-t-butyl-4-hydroxyphenyl) propionate
AO-2: neopentanetetrayltetrakis(3,5-di-t-butyl-4-hydroxydihydrocinnamate
S-1: neopentanetetrayltetrakis(3-laurylthiopropionate)
HA-1: poly[{6-(1,1,3,3-tetramethylbutyl)-1,3,5-triazine-2,4-diyl}{(2,2,6,6-tetramethyl-4-piperidyl)imino}hexamethylene(2,2,6,6-tetramethyl-4-piperidyl)imino}]
HA-2: bis(2,2,6,6-tetramethyl-4-piperidyl) sebacate

TABLE 4

| | | | Luminescent | | |
|---|---|---|---|---|---|
| Sample | Coefficient of | | foreign | | |
| No. | variation (CV) | Haze | material | Color | Remarks |
| 2-1 | B | B | B | A | Inv. |
| 2-2 | A | A | B | A | Inv. |
| 2-3 | B | A | B | B | Inv. |
| 2-4 | C | C | C | B | Inv. |
| 2-5 | C | B | C | B | Inv. |
| 2-6 | D | D | E | C | Comp. |
| 2-7 | D | E | E | C | Comp. |
| 2-8 | B | B | B | A | Inv. |
| 2-9 | A | B | B | A | Inv. |
| 2-10 | A | A | A | A | Inv. |
| 2-11 | B | A | B | A | Inv. |
| 2-12 | C | C | C | B | Inv. |
| 2-13 | C | B | B | B | Inv. |
| 2-14 | D | E | E | C | Comp. |
| 2-15 | B | B | A | A | Inv. |
| 2-16 | B | B | B | A | Inv. |
| 2-17 | C | C | C | A | Inv. |
| 2-18 | D | E | E | C | Comp. |
| 2-19 | B | A | B | A | Inv. |
| 2-20 | A | A | A | A | Inv. |
| 2-21 | D | E | E | C | Comp. |
| 2-22 | B | B | A | A | Inv. |
| 2-23 | A | B | A | A | Inv. |
| 2-24 | A | A | A | A | Inv. |
| 2-25 | D | D | E | C | Comp. |
| 2-26 | B | A | A | A | Inv. |
| 2-27 | B | B | A | A | Inv. |
| 2-28 | D | E | D | C | Comp. |

Inv.: Inventive sample,
Comp.: Comparative sample

As is clear from the above table, it is to be understood that Inventive sample Nos. 2-1, 2-2, 2-3, 2-4, 2-5, 2-1, 2-8, 2-9, 2-10, 2-11, 2-12, 2-13, 2-15, 2-16, 2-17, 2-19, 2-20, 2-22, 2-23, 2-24, 2-26 and 2-27 exhibit excellent optical properties together with excellent coefficient of variation of retardation and haze in comparison to those of Comparative sample Nos. 2-6, 2-7, 2-14, 2-18, 2-21, 2-25 and 2-28.

Polarizing plate protective films, polarizing plates and liquid crystal displays were prepared, and the same results as in Example 1 were obtained.

Similarly to Example 1, cellulose ester films having a kind of cellulose ester, a water content, a kind of additives and an addition amount as described in Table 5 were prepared. Results evaluated as above were shown in Table 6.

TABLE 5

| *2 | *3 | *4 | Plasticizer | *5 | Compound | *5 | *6 | *5 | *7 | *6 | *8 |
|---|---|---|---|---|---|---|---|---|---|---|---|
| 3-1 | C-1 | 1.0 | Chemical 16 | 8 | Compound 1 | 0.5 | | | | | Inv. |
| 3-2 | C-2 | 1.0 | Chemical 16 | 8 | Compound 1 | 0.5 | | | | | Inv. |
| 3-3 | C-3 | 1.0 | Chemical 16 | 8 | Compound 1 | 0.5 | | | | | Inv. |
| 3-4 | C-4 | 1.0 | Chemical 16 | 8 | Compound 1 | 0.5 | | | | | Inv. |
| 3-5 | C-4 | 1.0 | *1 | 8 | Compound 1 | 0.5 | | | | | Inv. |
| 3-6 | C-3 | 1.0 | Chemical 16 | 8 | Compound 1 | 0.5 | AO-2 | 0.2 | | | Comp. |
| 3-7 | C-3 | 1.0 | Chemical 16 | 8 | Compound 1 | 0.5 | HA-2 | 0.2 | | | Comp. |
| 3-8 | C-3 | 1.0 | Chemical 16 | 8 | Compound 2 | 0.5 | AO-2 | 0.1 | HA-2 | 0.1 | Inv. |

Inv.: Inventive sample,
Comp.: Comparative sample
*1: Pentaerythritoltetrabenzoate,
*2: Sample No.
*3: Cellulose ester
*4: Water content (% by weight)
*5: Addition amount (parts by weight)
*6: Stabilizer 1
*7: Stabilizer 2
*8: Remarks
C-3: Cellulose acetate propionate (a substitution degree of an acetyl group of 1.9, a substitution degree of a propionyl group of 0.8, molecular weight: Mn = 70,000, Mw = 220,000, and Mw/Mn of 3)
C-4: Cellulose triacetate

TABLE 6

| | | | Luminescent | |
|---|---|---|---|---|
| Sample | Coefficient of | | Foreign | |
| No. | variation (CV) | Haze | Materials | Remarks |
| 3-1 | B | A | A | Inv. |
| 3-2 | A | B | B | Inv. |
| 3-3 | A | A | A | Inv. |
| 3-4 | B | B | A | Inv. |
| 3-5 | B | B | A | Inv. |
| 3-6 | B | A | A | Inv. |
| 3-7 | A | A | B | Inv. |
| 3-8 | A | A | A | Inv. |

Inv.: Inventive sample

As is clear from the above table, it is to be understood that Inventive sample Nos. 3-1, 3-2, 3-3, 3-4, 3-5, 3-6, 3-7 and 3-8 exhibit excellent optical properties together with excellent coefficient of variation of retardation and haze.

Polarizing plate protective films, polarizing plates and liquid crystal displays were prepared, and the same results as in Example 1 were obtained.

### POSSIBILITY OF INDUSTRIAL USE

The present invention is possible to provide a cellulose ester film which can reduce a manufacturing burden and a facility burden caused by drying and recovering of a solvent used in the production process, a manufacturing method of the cellulose ester film and an optical film, and to specifically provide a polarizing plate employing the optical film as an excellent polarizing plate protective film exhibiting reduced fluctuation of retardation property in the width direction and a liquid crystal display employing the polarizing plate.

What is claimed is:

1. A cellulose ester film comprising a compound having a phenol structure and a phosphite ester structure in the molecule.

2. The cellulose ester film of claim 1,
wherein the compound is represented by Formula (I): 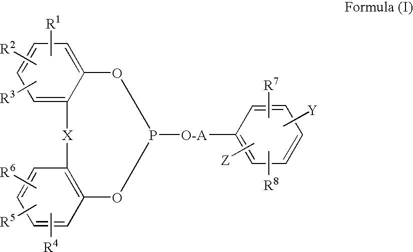
wherein each of R¹, R², R⁴, R⁵, R⁷ and R⁸ independently represents a hydrogen atom, an alkyl group having 1-8 carbon atoms, a cycloalkyl group having 5-8 carbon atoms, an alkylcycloalkyl group having 6-12 carbon atoms, an aralkyl group having 7-12 carbon atoms or a phenyl group;
each of R³ and R⁶ independently represents a hydrogen atom or an alkyl group having 1-8 carbon atoms;
X represents a single bond, a sulfur atom or a —CHR⁹-group (R⁹ represents a hydrogen atom, an alkyl group having 1-8 carbon atoms or a cycloalkyl group having 5-8 carbon atoms);
A represents an alkylene group having 2-8 carbon atoms or a *—COR¹⁰— group (R¹⁰ represents a single bond or an alkylene group having 1-8 carbon atoms, and * represents a bond combining with an oxygen atom); and
either Y or Z represents a hydroxyl group, an alkoxy group having 1-8 carbon atoms or an aralkyloxy group having 7-12 carbon atoms, and the other represents a hydrogen atom or an alkyl group having 1-8 carbon atoms.

3. The cellulose ester film of claim 1,
wherein the cellulose ester film comprises one stabilizer selected from the group consisting of a phenol stabilizer, a hindered amine stabilizer, a phosphorus stabilizer and a sulfur stabilizer in an amount of 0.01-5 parts by weight, based on 100 parts by weight of the cellulose ester.

4. The cellulose ester film of claim 1,
wherein the cellulose ester contained in the cellulose ester film comprises one selected from the group consisting of cellulose acetate, cellulose propionate, cellulose butyrate, cellulose acetate propionate, cellulose acetate butyrate, cellulose acetate phthalate and cellulose phthalate.

5. The cellulose ester film of claim 1, containing at least one of an ester plasticizer formed from a polyhydric alcohol and a monocarboxylic acid, and an ester plasticizer formed from a polycarboxylic acid and a monoalcohol.

6. The cellulose ester film of claim 5,
wherein the ester plasticizer formed from a polyhydric alcohol and a monocarboxylic acid, and the ester plasticizer formed from a polycarboxylic acid and a monoalcohol are alkyl polyhydric alcohol aryl ester and dialkyl carboxylic acid alkyl ester, respectively.

7. An optical film comprising the cellulose ester film of claim 1.

8. A polarizing plate comprising the optical film of claim 7 provided on at least one surface of a polarizer.

9. A liquid crystal display device having at least one of the optical film of claim 7 and the polarizing plate of claim 8.

10. A method of manufacturing the cellulose ester film comprising the step of:
heat-melting at a melting temperature of 150-300° C. an admixture containing:
the cellulose ester of having a water content of 3.0% by weight or less;
at least one of the ester plasticizer formed from a polyhydric alcohol and a monocarboxylic acid, and the ester plasticizer formed from a polycarboxylic acid and a monoalcohol; and
at least one compound having a phenol structure and a phosphite ester structure in a molecule to obtain the cellulose ester film via a melt cast method,
wherein the at least one of the ester plasticizer formed from a polyhydric alcohol and a monocarboxylic acid, and the ester plasticizer formed from a polycarboxylic acid and a monoalcohol, and the at least one compound having a phenol structure and a phosphite ester structure in a molecule have a content of 1-30% by weight and a content of 0.01-5% by weight, based on the weight of the cellulose ester.
